(19) United States
(12) Patent Application Publication
(10) Pub. No.: US 2019/0370282 A1
(43) Pub. Date: Dec. 5, 2019

(54) DIGITAL ASSET MANAGEMENT TECHNIQUES

(71) Applicant: Apple Inc., Cupertino, CA (US)

(72) Inventors: Guillaume Vergnaud, Tokyo (JP); Eric Circlaeys, Los Gatos, CA (US)

(73) Assignee: Apple Inc., Cupertino, CA (US)

(21) Appl. No.: 16/136,079

(22) Filed: Sep. 19, 2018

Related U.S. Application Data
(60) Provisional application No. 62/679,869, filed on Jun. 3, 2018.

(51) Int. Cl. G06F 16/483; G06N 3/08; G06F 16/174; G06K 9/62; G06F 16/435

(52) U.S. Cl. CPC G06F 16/483; G06N 3/08; G06F 16/435; G06K 9/6215; G06F 16/1748

(57) ABSTRACT

Embodiments of the present disclosure present devices, methods, and computer-readable medium for managing/presenting digital assets of a digital asset collection. The disclosed techniques enable a set of digital assets associated with a collection of related digital assets to be provided to a user. An initial set of digital assets associated with a collection of related digital assets may be identified. The set may be grouped into subsets based at least in part on capture times. Content metadata may be generated for each digital asset in a subset utilizing a neural network that is trained to identify features appearing within a digital asset. Content metadata of two digital assets may be compared to determine whether the assets are semantically similar. When two (or more) digital assets are semantically similar, at least one of the two digital assets may be excluded from a filtered set eventually presented at the user interface.

### CROSS-REFERENCES TO RELATED APPLICATIONS

This application is related to commonly-owned U.S. patent application Ser. No. 15/391,276, filed Dec., 27, 2016, entitled “Knowledge Graph Metadata Network Based on Notable Moments,” which is incorporated by reference in its entirety and for all purposes. This application claims priority to U.S. Provisional Patent Application No. 62/679,869, filed on Jun. 3, 2018, entitled “Digital Asset Management Techniques,” the disclosure of which is hereby incorporated by reference in its entirety for all purposes.

### BACKGROUND

Modern computing devices provide the opportunity to store thousands of digital assets (e.g., digital photos, digital video, etc.) in an electronic device. Users often show their digital assets to others by presenting the images on the display screen of the computing device. In the age of smartphones, users may often take many photos and/or videos of their travels and/or daily lives. Determining when digital assets (e.g., digital photos, digital videos, etc.) are related can be difficult without requiring the user to categorize the assets. Once the digital assets are categorized, many similar photos/videos may be presented, causing the user to have to sift through a potentially large amount of assets in order to find a particular photo or to get a sense of the event/activity that the user was attempting to capture in the first place. In order to avoid reviewing duplicate assets (or substantially duplicate assets) in the future, the user is typically required to manually delete the assets they no longer wish to keep. These requirements can be time-intensive for the user and waste resources of the user's device.

### SUMMARY

Embodiments of the present disclosure can provide devices, methods, and computer-readable medium for organizing and presenting filtered digital assets sets determined from a collection of digital assets captured by a user (e.g., during an event, during an activity, at a location, over time, etc.). The present disclosure enables a user to select a collection of related digital assets (e.g., each digital asset of the collection being related to “Angle Lake Park 2018”) to quickly access a representative set of digital assets (e.g., photos, videos, etc.) associated with the collection of related digital assets. The disclosed techniques allow for the digital asset set to be filtered by removing semantically similar images in order to provide the representative set. By reducing the set of digital assets presented to the user, the filtered set of digital images provide a more interesting and more easily perusable set of assets. Conventional techniques of removing duplicate digital assets may utilize image and/or video processing techniques to compare pixels between two images/videos. However, these techniques can still produce images/videos that are quite similar merely because the images/videos may contain the same content, albeit arranged at different locations within the image/video. The present disclosure solves these drawbacks by utilizing content metadata to determine semantically similar images/videos. “Content metadata” may identify objects/characteristics that appear within the digital asset (e.g., an image, a video, etc.) regardless of the location at which they appear. Content metadata of two digital assets may be to determine whether, contextually, the digital assets include the same type of content, regardless of arrangement. If the content metadata comparison indicates a degree of similarity over a threshold amount, one digital asset can be retained and the other discarded. Thus, semantically similar images are identified and filtered such that the resultant set of digital assets provides a representative view of the collection of related digital assets, while avoiding semantically duplicative assets.

In some embodiments, a computer-implemented method is enabled. The method may comprise maintaining, by one or more processors of a computing device, a knowledge graph comprising a plurality of nodes associated with respective sets of digital assets of a digital asset collection stored at the computing device. The method may further comprise receiving, at a user interface of the computing device, selection of a collection of related digital assets. The method may further comprise identifying, by the one or more processors and based at least in part on the selection, a set of digital assets associated with the collection of related digital assets, the set of digital assets being associated with a collection node of the plurality of nodes of the knowledge graph, the collection node corresponding to the selection. The method may further comprise generating, by the one or more processors, a subset of digital assets from the set of digital assets identified based at least in part on capture time data associated with respective digital assets of the set of digital assets. The method may further comprise generating, by the one or more processors and utilizing a neural network, content metadata for each digital asset of the digital assets of the subset of digital assets, the content metadata for a digital asset including a plurality of confidence scores that individually describe a degree of confidence that a feature is included in the digital asset. In some embodiments, the neural network is trained with previously categorized digital assets to identify a plurality of features. The neural network may be configured to receive the digital asset as input, and wherein the neural network is configured to output content metadata for the digital asset. In some embodiments, a feature corresponds to at least one of: an object that appears in the digital asset or a characteristic of the digital asset. The method may further comprise calculating, by the one or more processors, a distance value quantifying a degree of similarity between first content metadata associated with a first digital asset of the subset of digital assets and second content metadata associated with a second digital asset of the subset of digital assets. In some embodiments, calculating the distance value may include comparing a first plurality of confidence scores of the first content metadata to a second plurality of confidence scores of the second content metadata. The method may further comprise generating, based at least in part on a determination that the distance value is below a threshold value, a filtered set of digital assets that includes the first digital asset and excludes the second digital asset from the filtered set of digital assets. The method may further comprise presenting, at a display of the computing device and based at least in part on the selection, the filtered set of digital assets as being associated with the collection of related digital assets.

In some embodiments, a computing device is described. The computing device may comprise one or more memories and one or more processors in communication with the one or more memories and configured to execute instructions stored in the one or more memories to cause the computing device to perform operations. The operations may include obtaining a knowledge graph of a collection of metadata associated with a collection of digital assets stored at the computing device. The operations may further include receiving, at a user interface, selection of a collection of related digital assets. The operations may further include determining a set of digital assets associated with the collection of related digital assets based at least in part on the knowledge graph. The operations may further include determining a subset of digital assets from the set of digital asset based at least in part on capture times associated with each digital asset of the set of digital assets. The operations may further include generating content metadata for each digital asset of the subset of digital assets, the content metadata for each digital asset of the subset of digital assets including a plurality of confidence scores that individually describe a degree of confidence that a feature is included in a digital asset. The operations may further include identifying two or more semantically similar digital assets based at least in part on corresponding content metadata of the subset of digital assets. The operations may further include generating a filtered set of digital assets that includes one of the two or more semantically similar digital assets. The operations may further include presenting, at the computing device, the filtered set of digital assets.

In some embodiments, the two or more semantically similar digital assets may be identified based at least in part on comparing the content metadata for each digital asset of the subset of digital assets to other content metadata of the subset of digital assets to determine two or more semantically similar digital assets, and generating one or more distance values that individually quantify a degree of similarity between two digital assets based at least in part on comparing the content metadata for each digital asset of the subset of digital assets to other content metadata of the remaining digital assets of the subset of digital assets, wherein two digital assets are considered semantically similar when a corresponding distance value is less than a threshold value.

In some embodiments, the operations may further include preparing for display a user interface that includes user interface elements, wherein each user interface element of the user interface elements may identify the collection of related digital assets and a corresponding multimedia icon that represents a corresponding digital asset associated with the collection of related digital assets. The operations may further include receiving a selection of at least one of the user interface elements, wherein the filtered set of digital assets may be presented based at least in part on the selection received.

In some embodiments, the operations may further include presenting, with the filtered set of digital assets, location information corresponding to capture locations associated with the filtered set of digital assets.

In some embodiments, the operations may further include displaying related sets of digital assets with the filtered set of digital assets. In some embodiments, the operations may further include presenting, with the filtered set of digital assets, related sets of digital assets that relate to the filtered set of digital assets by at least one attribute of corresponding metadata of the filtered set of digital assets.

In some embodiments, the operations may further include receiving, at a user interface of the computing device, a selection associated with a filter option. For example, the additional digital assets of the set of digital assets may be presented with the filtered set of digital assets.

In some embodiments, the operations may further include providing, at the user interface, a video including the filtered set of digital assets.

In some embodiments, generating the filtered set of digital asset may further include operations for determining a plurality of aesthetic scores associated with the two or more semantically similar digital assets, selecting a highest aesthetic score of the plurality of aesthetic scores, and including, in the filtered set of digital assets, a particular digital asset associated with the highest aesthetic score.

In some embodiments, generating the content metadata for each digital asset of the subset of digital assets may include operations for providing, to a neural network, each digital asset of the subset of digital assets as input. In some embodiments, the neural network may be previously trained to identify one or more features appearing in an inputted digital asset, the neural network outputting the content metadata for each digital asset of the subset of digital assets. In some embodiments, the content metadata may include a plurality of confidence scores that individually describe a degree of confidence that a feature of the one or more features appears in a digital asset.

In some embodiments, a computer-readable medium may be utilized to store a plurality of instructions. These instructions, when executed by one or more processors of a computing device, may cause the one or more processors to perform various operations. For example, the operations may include receiving, at a user interface, a selection of a collection of related digital assets associated with one or more digital assets of a digital asset collection. The operations may further include identifying the one or more digital assets associated with the collection of related digital assets. The operations may further include determining a subset of digital assets from the one or more digital assets based at least in part on capture times associated with each digital asset of the one or more digital assets. The operations may further include generating content metadata for each digital asset of the subset of digital assets, the content metadata including a plurality of confidence scores that individually describe a degree of confidence that a feature is included in a digital asset. In some embodiments, the feature corresponds to at least one of: an object that appears in the digital asset or a characteristic of the digital asset. In some embodiments, the feature may include a combination of objects appearing in a digital asset. The operations may further include identifying two or more semantically similar digital assets based at least in part on corresponding content metadata of the two or more semantically similar digital assets. The operations may further include generating a filtered set of digital assets, the filtered set of digital assets excluding at least one of the two or more semantically similar digital assets. The operations may further include presenting, at the computing device, the filtered set of digital assets.

In some embodiments, the filtered set of digital assets may be generated by obtaining aesthetic scores for the two or more semantically similar digital assets and including, in the filtered set of digital assets, a digital asset corresponding to a highest aesthetic score of the aesthetic scores. In some embodiments, the aesthetic scores may individually quantify a quality of content of each of the two or more semantically similar digital assets.

In some embodiments, the operations may further include identifying subjects of the filtered set of digital assets based at least in part on executing facial recognition techniques with the filtered set of digital assets, and/or presenting, with the filtered set of digital assets, icons corresponding to the subject identified.

In some embodiments, the filtered set of digital assets may provide a representative set of digital assets of the one or more digital assets that excludes duplicative digital assets.

In some embodiments, a common feature included in the two or more semantically similar digital assets may appear in different locations within the two or more semantically similar digital assets.

The following detailed description together with the accompanying drawings will provide a better understanding of the nature and advantages of the present disclosure.

### BRIEF DESCRIPTION OF THE DRAWINGS

FIG. 1 is a simplified block diagram illustrating an example flow for providing a filtered set of digital assets related to a collection of related digital assets as described herein, in accordance with at least one embodiment.

FIG. 2 illustrates an example user interface for enabling selection of a collection of related digital assets, in accordance with at least one embodiment.

FIG. 3 illustrates another example user interface for providing a filtered set of digital assets associated with a particular collection of related digital assets, in accordance with at least one embodiment.

FIG. 4 illustrates additional user interface elements for presenting content related to a filtered set of digital assets associated with a particular collection of related digital assets, in accordance with at least one embodiment.

FIG. 5 illustrates another example process of generating a filtered set of digital assets related to a collection of related digital assets, in accordance with at least one embodiment.

FIG. 6 is a flow diagram to illustrate a process for generating a filtered set of digital assets associated with a collection of related digital assets, in accordance with at least one embodiment.

FIG. 7 is another flow diagram to illustrate a process for generating a filtered set of digital assets associated with a collection of related digital assets, in accordance with at least one embodiment.

FIG. 8 is yet another flow diagram to illustrate a process for generating a filtered set of digital assets associated with a collection of related digital assets, in accordance with at least one embodiment.

FIG. 9 is a simplified block diagram illustrating is a computer architecture for providing filtered sets of digital assets as described herein, according to at least one embodiment.

### DETAILED DESCRIPTION

Certain embodiments of the present disclosure relate to devices, computer-readable medium, and methods for implementing various techniques for providing a filtered set of digital assets associated with a collection of digital assets. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. The present disclosure describes devices and methods for searching various digital assets (e.g., digital photos, digital video, etc.) stored in a digital asset collection on computing device.

### 1. Overview

Embodiments of the present disclosure are directed to, among other things, improving the efficient organization and storage of digital assets as well improving a user experience concerning the review of a digital asset collection. As used herein, a “digital asset” may include data that can be stored in or as a digital form (e.g., digital image, digital video, music files, digital voice recording). As used herein, a “digital asset collection” refers to multiple digital assets that may be stored in one or more storage locations. The one or more storage locations may be spatially or logically separated. As used herein, a “knowledge graph” refers to a metadata network associated with a collection of digital assets including correlated metadata assets describing characteristics associated with digital assets in the digital asset collection. As used herein, a “node” in a metadata network refers to a graph node (e.g., in a data structure) that represents metadata assets associated with one or more digital assets in a digital asset collection. In some embodiments, a “collection node” can be one type of node in the metadata network that corresponds to a particular collection of related digital assets and that is associated with a set of digital assets of the digital asset collection (e.g., photos of the collection of related digital assets). The examples and contexts of such examples provided herein are intended for illustrative purposes and not to limit the scope of this disclosure.

In at least one embodiment, the user may utilize a digital asset application to access a digital asset collection. Within the application, an option may be provided for accessing digital assets associated with a collection of related digital assets. Upon selecting the option, the user may be provided with a number of “collections” that can correspond to various groups of digital assets previously captured by the user. Each collection's digital assets may be related by at least one attribute (e.g., by event, location, capture time, subject, content, etc.). By way of example, one collection of related digital assets may correspond to digital photos and/or videos captured by the user at a particular location (e.g., Seattle, Washington) on a particular day (or other respective capture time). Another example collection of related digital assets may correspond to “Portraits of 2018” that may be associated with digital photos captured by the user (on any suitable device associated with the user) during the year 2018 in which a face (e.g., a portrait) is a prominent feature. Upon selecting a particular collection at the user interface, a representative set of digital assets (e.g., photos) associated with the collection may be presented at the interface. This representative set may exclude digital assets (in this case photos) that were determined to be semantically similar. Thus, instead of being provided every digital photo associated with “Portraits of 2018,” which may potentially include many semantically duplicative photos, a filtered set may be provided which provides semantically unique digital photos. The terms “semantically similar” and “semantically unique” are intended to refer to a degree of content similarity or difference between digital assets that is irrespective the location of particular features within the image. As a non-limiting example, an image that includes a car appearing to the right of a person in the image may be determined to be semantically similar to another image that includes a car appearing to the left of the person based on the car appearing in each image. While techniques that compare pixels to determine similarity would have found the images to be distinct, the analysis described herein identifies the two images noted above as being semantically similar. Further examples may be provided in more detail below.

### 2. Knowledge Graph

In some embodiments, a digital asset management module/logic obtains or generates a knowledge graph metadata network (hereinafter “knowledge graph”) to identify digital assets of the collection from with the filtered set will be generated. The metadata network can comprise of correlated metadata assets describing characteristics associated with digital assets in the digital asset collection. Each metadata asset can describe a characteristic associated with one or more digital assets in the digital asset collection. In a non-limiting example, a metadata asset can describe a characteristic associated with multiple digital assets in the digital asset collection. Each metadata asset can be represented as a node in the metadata network. A metadata asset can be correlated with at least one other metadata asset. Each correlation between metadata assets can be represented as an edge in the metadata network that is between the nodes representing the correlated metadata assets. In some embodiments, the digital asset management module/logic identifies a first metadata asset in the metadata network. The digital asset management module/logic can also identify a second metadata asset based on at least the first metadata asset. In some embodiments, the digital asset management module/logic causes one or more digital assets with the first and/or second metadata assets to be presented via an output device.

In some embodiments, the digital asset management module/logic can enable the system to generate and use and knowledge graph of the digital asset metadata as a multidimensional network. The digital asset management module/logic can obtain or receive a collection of digital asset metadata associated with the digital asset collection. The digital assets stored in the digital asset collection includes, but is not limited to, the following: image media (e.g., still or animated image, etc.); audio media (e.g., a digital sound file); text media (e.g., an e-book, etc.); video media (e.g., a movie, etc.); and haptic media (e.g., vibrations or motions provided in connection with other media, etc.). The examples of digitized data above can be combined to form multimedia (e.g., an animated movie, a videogame etc.). A single digital asset refers to a single instance of digitized data (e.g., an image, a song, a movie, etc.).

As used herein, “metadata” and “digital asset metadata” collectively referred to information about one or more digital assets. Metadata can be: (i) a single instance of information about digitized data (e.g., a timestamp associated with one or more images, etc.); or (ii) a grouping of metadata, which refers to a group comprised of multiple instances of information about digitized data (e.g., several timestamps associated with one or more images etc.). There are different types of metadata. Each type of metadata describes one or more characteristics or attributes associated with one or more digital assets. Each metadata type can be categorized as primitive metadata or inferred metadata, as described further below.

In some embodiments, the digital asset management module/logic can identify primitive metadata associated with one or more digital assets within the digital asset metadata. In some embodiments, the digital asset management module/logic may determine inferred metadata based on at least on the primitive metadata. As used herein, “primitive metadata” refers to metadata that describes one or more characteristics or attributes associated with one or more digital assets. That is, primitive metadata includes acquired metadata describing one or more digital assets. In some cases, primitive metadata can be extracted from inferred metadata, as described further below.

Primary primitive metadata can include one or more of: time metadata, Geo-position metadata; geolocation metadata; people metadata; scene metadata; content metadata; object metadata; and sound metadata. Time metadata refers to a time associated with one or more digital assets (e.g., a timestamp associated with the digital asset, a time the digital asset is generated, a time the digital asset is modified, a time the digital asset is stored, a time the digital asset is transmitted, a time the digital asset is received, etc.). Geo-position metadata refers to geographic or spatial attributes associated with one or more digital assets using a geographic coordinate system (e.g., latitude, longitude, and/or altitude, etc.). Geolocation metadata refers to one or more meaningful locations associated with one or more digital assets rather than geographic coordinates associated with digital assets. Examples include a beach (and its name), a street address, a country name, a region, a building, a landmark, etc. Geolocation metadata can, for example, be determined by processing geographic position information together with data from a map application to determine that the geolocation for a scene in a group of images. People metadata refers to at least one detected or known person associated with one or more digital assets (e.g., a known person in an image detected through facial recognition techniques, etc.).

Scene metadata refers to an overall description of an activity or situation associated with one or more digital assets. For example, if a digital asset includes a group of images, then scene metadata for the group of images can be determined using detected objects in images. For more specific example, the presence of a large cake with candles and balloons in at least two images in the group can be used to determine that the scene for the group of images is a birthday celebration. Object metadata refers to one or more detected objects associated with one or more digital assets (e.g., a detected animal, a detected company logo, a detected piece of furniture, etc.). Capture metadata refers to features of digital assets (e.g., pixel characteristics, pixel intensity values, luminescence values, brightness values, loudness levels, etc.). Sound metadata refers to one or more detected sounds associated with one or more digital assets (e.g., detected sound is a human's voice, a detected sound as a fire truck's siren etc.).

Auxiliary primitive metadata includes, but is not limited to, the following: (i) a condition associated with capturing the one or more digital assets; (ii) the condition associated with modifying one or more digital assets; and (iii) a condition associated with storing or retrieving one or more digital assets. As used herein “inferred metadata” refers to additional information about one or more digital assets that is beyond the information provided by primitive metadata. One difference between primitive metadata and inferred metadata is that primitive metadata represents an initial set of descriptions of one or more digital assets while inferred metadata provides additional descriptions of the one or more digital assets based on processing of one or more of the primitive metadata and contextual information.

By way of example, primitive metadata can be used to identify detected persons in a group of images as John Doe and Jane duo, one inferred metadata may identify John Doe and Jane Doe as a married couple based on processing one or more of the primitive metadata (i.e., the initial set of descriptions and contextual information). In some embodiments, inferred metadata is formed from at least one of: (i) a combination of different types of primitive metadata; (ii) a combination of different types of contextual information; (iii) or a combination of primitive metadata and contextual information. As used herein, “contacts” and its variations refer to any or all attributes of a user's device that includes or has access to a digital asset collection associated with the user, such as physical, logical, social, and/or other contact contextual information. As used herein, “contextual information” and its variation refer to metadata assets that describes or defines the user's context or context of a user's device that includes or has access to a digital asset collection associated with the user. Exemplary contextual information includes, but is not limited to, the following: a predetermined time interval; an event scheduled to occur at a predetermined time interval; a geolocation to be visited at a predetermined time interval; one or more identified persons associated with a predetermined time; an event scheduled for predetermined time, or geolocation to be visited a predetermined time; whether metadata describing whether associated with a particular period of time (e.g., rain, snow, windy, cloudy, sunny, hot, cold, etc.); Season related metadata describing a season associated with capture of the image. For some embodiments, the contextual information can be obtained from external sources, a social networking application, a weather application, a calendar application, and address book application, any other type of application, or from any type of data store accessible via wired or wireless network (e.g., the Internet, a private intranet, etc.).

Primary inferred metadata can include event metadata describing one or more events associated with one or more digital assets. For example, if a digital asset includes one or more images, the primary inferred metadata can include event metadata describing one or more events where the one or more images were captured (e.g., vacation, a birthday, a sporting event, a concert, a graduation ceremony, a dinner, project, a workout session, a traditional holiday etc.). Primary inferred metadata can in some embodiments, be determined by clustering one or more primary primitive metadata, auxiliary primitive metadata, and contextual metadata. Auxiliary inferred metadata includes but is not limited to the following: (i) geolocation relationship metadata; (ii) person relationship metadata; (iii) object relationship metadata; space and (iv) sound relationship metadata. Geolocation relationship metadata refers to a relationship between one or more known persons associated with one or more digital assets and on one or more meaningful locations associated with the one or more digital assets. For example, an analytics engine or data meeting technique can be used to determine that a scene associated with one or more images of John Doe represents John Doe's home. Personal relationship metadata refers to a relationship between one or more known persons associated with one or more digital assets and one or more other known persons associated with one or more digital assets. For example, an analytics engine or data mining technique can be used to determine that Jane Doe (who appears in more than one image with John Doe) is John Doe's wife. Object relationship metadata refers to relationship between one or more known objects associated with one or more digital assets and one or more known persons associated with one or more digital assets. For example, an analytics engine or data mining technique can be used to determine that a boat appearing in one or more images with John Doe is owned by John Doe. Sound relationship metadata refers to a relationship between one or more known sounds associated with one or more digital asset and one or more known persons associated with the one or more digital assets. For example, an analytics engine or data mining technique can be used to determine that a voice that appears in one or more videos with John Doe is John Doe's voice.

As explained above, inferred metadata may be determined or inferred from primitive metadata and/or contextual information by performing at least one of the following: (i) data mining the primitive metadata and/or contextual information; (ii) analyzing the primitive metadata and/or contextual information; (iii) applying logical rules to the primitive metadata and/or contextual information; or (iv) any other known methods used to infer new information from provided or acquired information. Also, primitive metadata can be extracted from inferred metadata. For a specific embodiment, primary primitive metadata (e.g., time metadata, geolocation metadata, scene metadata, etc.) can be extracted from primary inferred metadata (e.g., event metadata, etc.). Techniques for determining inferred metadata and/or extracting primitive metadata from inferred metadata can be iterative. For a first example, inferring metadata can trigger the inference of other metadata and so on primitive metadata from inferred metadata can trigger inference of additional inferred metadata or extraction of additional primitive metadata.

The primitive metadata and the inferred metadata described above are collectively referred to as the digital asset metadata. In some embodiments, the digital asset maintenance module/logic uses the digital asset metadata to generate a knowledge graph. All or some of the metadata network can be stored in the processing unit(s) and/or the memory. As used herein, a “knowledge graph,” a “knowledge graph metadata network,” a “metadata network,” and their variations refer to a dynamically organized collection of metadata describing one or more digital assets (e.g., one or more groups of digital assets in a digital asset collection, one or more digital assets in a digital asset collection, etc.) used by one or more computer systems for deductive reasoning. In a metadata network, there is no digital assets—only metadata (e.g., metadata associated with one or more groups of digital assets, metadata associated with one or more digital assets, etc.). Metadata networks differ from databases because, in general, a metadata network enables deep connections between metadata using multiple dimensions, which can be traversed for additionally deduced correlations. This deductive reasoning generally is not feasible in a conventional relational database without loading a significant number of database tables (e.g., hundreds, thousands, etc.). As such, conventional databases may require a large amount of computational resources (e.g., external data stores, remote servers, and their associated communication technologies, etc.) to perform deductive reasoning. In contrast, a metadata network may be viewed, operated, and/or stored using fewer computational resource requirements than the preceding example of databases. Furthermore, metadata networks are dynamic resources that have the capacity to learn, grow, and adapt as new information is added to them. This is unlike databases, which are useful for accessing cross-referred information. While a database can be expanded with additional information, the database remains an instrument for accessing the cross-referred information that was put into it. Metadata networks do more than access cross-referred information—they go beyond that and involve the extrapolation of data for inferring or determining additional data.

As explained in the preceding paragraph, a metadata network enables deep connections between metadata using multiple dimensions in the metadata network, which can be traversed for additionally deduced correlations. Each dimension in the metadata network may be viewed as a grouping of metadata based on metadata type. For example, a grouping of metadata could be all time metadata assets in a metadata collection and another grouping could be all geo-position metadata assets in the same metadata collection. Thus, for this example, a time dimension refers to all time metadata assets in the metadata collection and a geo-position dimension refers to all geo-position metadata assets in the same metadata collection. Furthermore, the number of dimensions can vary based on constraints. Constraints include, but are not limited to, a desired use for the metadata network, a desired level of detail, and/or the available metadata or computational resources used to implement the metadata network. For example, the metadata network can include only a time dimension, the metadata network can include all types of primitive metadata dimensions, etc. With regard to the desired level of detail, each dimension can be further refined based on specificity of the metadata. That is, each dimension in the metadata network is a grouping of metadata based on metadata type and the granularity of information described by the metadata. For a first example, there can be two time dimensions in the metadata network, where a first time dimension includes all time metadata assets classified by week and the second time dimension includes all time metadata assets classified by month. For a second example, there can be two geolocation dimensions in the metadata network, where a first geolocation dimension includes all geolocation metadata assets classified by type of establishment (e.g., home, business, etc.) and the second geolocation dimension includes all geolocation metadata assets classified by country. The preceding examples are merely illustrative and not restrictive. It is to be appreciated that the level of detail for dimensions can vary depending on designer choice, application, available metadata, and/or available computational resources.

The digital asset management module/logic can be configured to generate the metadata network as a multidimensional network of the digital asset metadata. As used herein, “multidimensional network” and its variations refer to a complex graph having multiple kinds of relationships. A multidimensional network generally includes multiple nodes and edges. For one embodiment, the nodes represent metadata, and the edges represent relationships or correlations between the metadata. Exemplary multidimensional networks include, but are not limited to, edge labeled multi-graphs, multipartite edge labeled multi-graphs and multilayer networks.

For one embodiment, the nodes in the metadata network represent metadata assets found in the digital asset metadata. For example, each node represents a metadata asset associated with one or more digital assets in a digital asset collection. For another example, each node represents a metadata asset associated with a group of digital assets in a digital asset collection. As used herein, “metadata asset” and its variation refer to metadata (e.g., a single instance of metadata, a group of multiple instances of metadata, etc.) Describing one or more characteristics of one or more digital assets in a digital asset collection. As such, there can be primitive metadata asset, inferred metadata asset, a primary primitive metadata asset, and exhilarate primitive metadata asset, a primary inferred metadata asset, and/or and exhilarate inferred metadata asset. For a first example, a primitive metadata asset refers to a time metadata asset describing a time interval between Jun. 1, 2016 and Jun. 3, 2016 when one or more digital assets were captured. For a second example, a primitive metadata asset refers to a geo-position metadata asset describing one or more latitudes and/or longitudes where one or more digital assets were captured. For another example, an inferred metadata asset refers to an event metadata asset describing a vacation in Paris, France between Jun. 5, 2016 and Jun. 30, 2016 when one or more digital assets were captured.

In some embodiments, the metadata network includes two types of nodes: (i) collection nodes; and (ii) non-collection nodes. As used herein, a “collection” may be associated with one or more related digital assets (as described by a collection metadata asset). For example, a collection (of related digital assets) may be associated with a vacation in Paris,

France that lasted between Jun. 1, 2016 and Jun. 9, 2016. The collection can be used to identify one or more digital assets (e.g., one image, a group of images, a video, a group of videos, a song, a group of songs, etc.) associated with the vacation in Paris, France that lasted between Jun. 1, 2016 and Jun. 9, 2016 (and not with any other collection). As used herein, a “collection node” refers to a node in a multidimensional network that represents a collection of related digital assets. Thus, a collection node may refer to a primary inferred metadata asset representing a single collection associated with one or more digital assets. Primary inferred metadata as described above. As used herein, a “non-collection node” may refer to a node in a multidimensional network that does not represent a collection. Thus a non-collection node refers to at least one of the following: (i) a primitive metadata asset associate with one or more digital assets; or (ii) and inferred metadata asset associated with one or more digital assets that is not a collection (i.e., not a collection metadata asset).

A “collection of related digital assets” may refer to one or more digital assets that were captured during a particular situation or activity (e.g., an event) occurring at one or more locations during a specific time interval. Events may include, but are not limited to the following: a gathering of one or more persons to perform an activity (e.g., a holiday, a vacation, a birthday, a dinner, a project, a workout session, etc.); a period of time (e.g., in the year 2017, photos of 2016, videos of 2015-2020, etc.) a sporting event (e.g., an athletic competition, etc.); a ceremony (e.g., a ritual of cultural significance that is performed on a special occasion, etc.); a meeting (e.g., a gathering of individuals engaged in some common interest, etc.); a festival (e.g., a gathering to celebrate some aspect in a community, etc.); a concert (e.g., an artistic performance, etc.); a media event (e.g., an event created for publicity, etc.); and a party (e.g., a large social or recreational gathering, etc.).

The knowledge graph can be generated and used to perform digital asset management in accordance with an embodiment. Generating the metadata network, by the digital asset management module/logic, can include defining nodes based on the primitive metadata and/or the inferred metadata associated with one or more digital assets in the digital asset collection. As a digital asset management module/logic identifies more primitive metadata with the metadata associated with a digital asset collection and/or infers metadata from at least the primitive metadata, the digital asset management module/logic can generate additional nodes to represent the primitive metadata and/or the inferred metadata. Furthermore, as the digital asset management module/logic determines correlations between the nodes, the digital asset management module/logic can create edges between the nodes. Two generation processes can be used to generate the metadata network. The first generation process is initiated using a metadata asset that does not describe a collection event (e.g., primary primitive metadata asset, and auxiliary primitive metadata asset, and auxiliary inferred metadata asset, etc.). The second generation process is initiated using a metadata asset that describes a collection event (e.g., event metadata). Each of these generation processes are described below.

For the first generation process, the digital asset management module/logic can generate a non-collection node to represent metadata associated with the user, a consumer, or an owner of a digital asset collection associated with the metadata network. For example a user can be identified as Jean DuPont. One embodiment, the digital asset management module/logic generates the non-collection node to represent the metadata provided by the user (e.g., Jean DuPont, etc.) via an input device. For example, the user can add at least some of the metadata about himself or herself to the metadata network via an input device. In this way, the digital asset management module/logic can use the metadata to correlate the user with other metadata acquired from a digital asset collection. For example, metadata provided by the user Jean DuPont can include one or more of his name's birthplace (which is Paris, France), his birthdate (which is May 27, 1991), his gender (which is male), his relations status (which is married), his significant other or spouse (which is Marie Dupont), and his current residence (which is in Key West, Fla., USA).

With regard to the first generation process, at least some of the metadata can be predicted based on processing performed by the digital asset management module/logic. The digital asset management module/logic may predict metadata based on analysis of metadata access the application or metadata and a data store (e.g., device memory). For example, the digital asset management module/logic may predict the metadata based on analyzing information acquired by accessing the user's contacts (via a contacts application), activities (the account or application or an organization application should), contextual information (via sensors or peripherals) and/or social networking data (via social networking application).

In some embodiments, the metadata includes, but is not limited to, other metadata such as a user's relationship with others (e.g., family members, friends, coworkers, etc.), the user's workplaces (e.g., past workplaces, present workplaces, etc.), Places visited by the user (e.g., previous places visited by the user, places that will be visited by the user, etc.). In at least one embodiment, the metadata can be used alone or in conjunction with other data to determine or infer at least one of the following: (i) vacations or trips taken by Jean Dupont; days of the week (e.g., weekends, holidays, etc.); locations associated with Jean Dupont; Jean Dupont's social group (e.g., his wife Marie Dupont, etc.); Jean Dupont's professional or other groups (e.g., groups based on his occupation, etc.); types of places visited by Jean Dupont (e.g., a restaurant, his home, etc.); activities performed (e.g., a work-out session, etc.); etc. The preceding examples are illustrative and not restrictive.

For the second generation process, the metadata network may include at least one collection node. For this second generation process, the digital asset management module/logic generates the collection node to represent one or more primary inferred metadata assets (e.g., an event metadata asset, etc.). The digital asset management module/logic can determine or infer the primary inferred metadata (e.g., an event metadata asset, etc.) From one or more information, the metadata, or other data received from external sources (e.g., whether application, calendar application, social networking application, address books, etc. Also, the digital asset management module/logic may receive the primary inferred metadata assets, generate this metadata as the collection node and extract primary primitive metadata from the primary inferred metadata assets represented as the collection node.

The knowledge graph can be obtained from memory. Additionally, or alternatively, the metadata network can be generated by processing units. The knowledge graph is created when a first metadata asset (e.g., a collection node, non-collection node, etc.) is identified in the multidimensional network representing the metadata network. For one embodiment, the first metadata can be represented as a collection node. For this embodiment the first metadata asset represents a first event associated with one or more digital assets. A second metadata asset is identified or detected based at least on the first metadata asset. The second metadata asset may be identified or detected in the metadata network is a second node (e.g., a collection node, etc.)

based on the first nose used to represent the first metadata asset in some embodiments, the second metadata asset is represented as a second collection node that differs from the first moment node. This is because the first collection node represents a first event metadata asset that describes a first event associated with one or more digital assets where the second collection node represents a second event metadata asset that describes the second event associated with one or more digital assets.

In some embodiments, identifying the second event metadata asset (e.g., a collection node, etc.) is performed by determining that the first and second event metadata assets share a primary primitive metadata asset, a primary inferred metadata asset, an auxiliary primitive metadata asset, and/or an auxiliary inferred metadata asset even though some of their metadata differ. Further explanation for using or generating a knowledge graph can be found in U.S. patent application Ser. No. 15,391,276, filed Dec., 27, 2016, entitled “Knowledge Graph Metadata Network Based on Notable Moments,” the disclosure of which is incorporated herein by reference in its entirety and for all purposes.

### 3. Filtering Techniques

In some embodiments, an initial set of digital assets (e.g., photos, videos, etc.) may be determined utilizing the knowledge graph. Once identified, the digital image management module may group those digital assets into any suitable number of subsets. By way of example, images associated with a collection of related digital assets could be grouped according to capture times. Thus, images that were captured within a time window (e.g., within a 90 second period of time), may be grouped in a subset. If the subset includes more than one image, the digital asset management module may generate content metadata for each of the images in the subset. “Content metadata” may include any suitable number of confidence scores which describe a degree of confidence that a feature (e.g., an object, a characteristic of the asset, a combination of object and characteristic) is included in the digital asset (in this case, an image).

By way of example, content metadata for an image can indicate that there is a 90% likelihood that a dog appears in the image, and/or an 80% likelihood that the image is that of a beach, and/or a 75% likelihood that the a car appears in the image. Each score need not necessarily correspond to a single object within the image. That is a confidence score can indicate that there is a 50% likelihood that a car, a dog, and a beach are included in the image.

The content metadata of the images in each subset may be compared to identify which images (if any) are semantically similar and exclude at least one of the semantically similar images from being included in the filtered set. In some embodiments, just one of the images of the semantically similar images may be included in the filtered set. Accordingly, rather than requiring the user to manually delete images, or manually associate particular images to a particular collection, a representative set of images may be generated for the user. Thus, the user can view/review a smaller image set to be reminded of an event or activity, or the smaller image set may provide a more succinct set of assets rather than potentially overwhelming the user with presenting every single image in a collection. It should be appreciated that any example that utilizes an “image” (e.g., a digital photo), or a “photo,” may equally be applied to examples in which another type of digital asset is utilized (e.g., a digital video, a combination of digital photos and videos, etc.).

The following figures discuss the aspects of this disclosure in more detail.

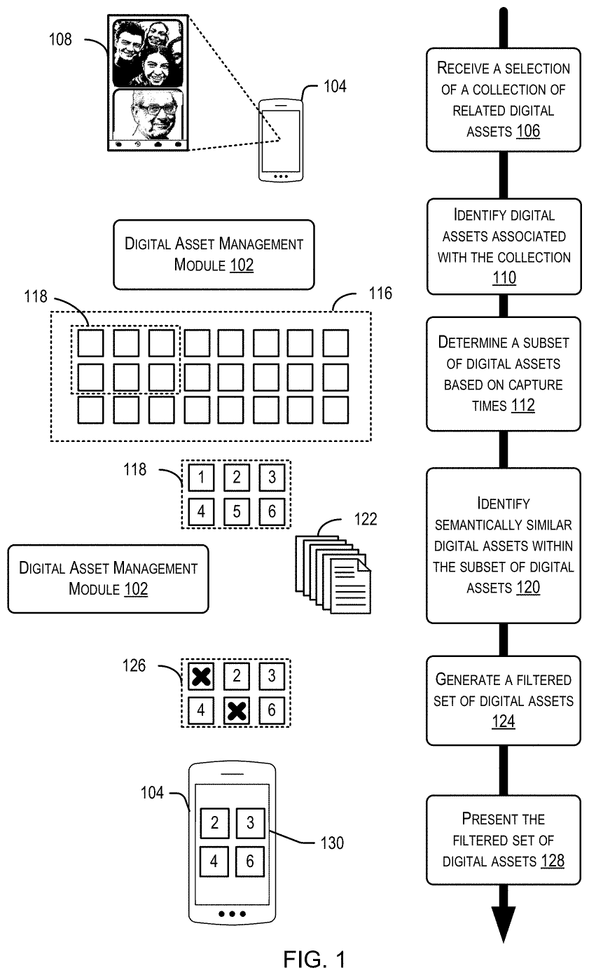

For example, FIG. 1 is a simplified block diagram illustrating an example flow 100 for providing a filtered set of digital assets related to a collection of related digital assets as described herein, in accordance with at least one embodiment. The operations of flow 100 may be provided by a digital asset management module 102 which may operate as part of a digital asset application for managing a digital asset collection (e.g., photos and/or videos) stored at a user device 104.

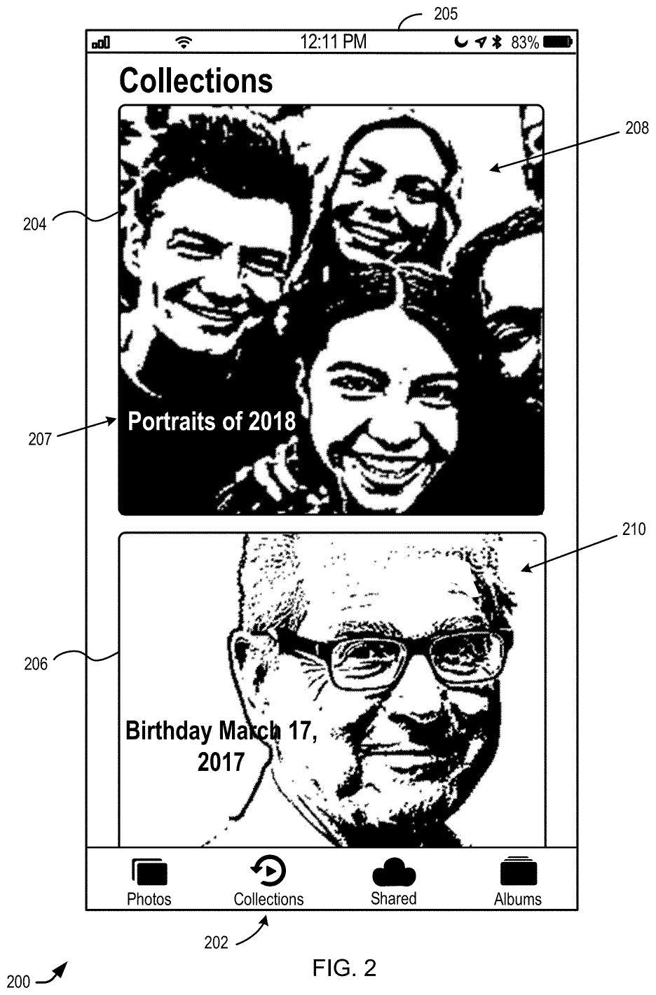

At block 106, a selection of a collection of related digital assets may be received by the digital asset application. In some embodiments, any suitable number of collections of related digital assets may be presented at a user interface of user device 104. By way of example, user interface 108 (described in more detail in FIG. 2) may provide a number of collections of related digital assets from which a user may select. In some embodiments, the user interface 108 may present a collection of related digital assets utilizing an icon which represents at least one digital asset (e.g., a photo, a video, etc.) of a set of digital assets associated with the collection of related digital assets.

At block 110, the digital asset management module 102 may utilize the selection received at block 106 to identify a set of digital assets associated with the selected collection. As a non-limiting example, the digital asset management module 102 may utilize the selection (e.g., a selection of a particular collection event icon) to identify a particular collection node of a knowledge graph. The knowledge graph, as described above, may include any suitable number of nodes and edges, where the nodes correspond to metadata associated with one or more digital assets and the edges represent correlations between nodes. In some embodiments, the digital asset management module 102 may identify a particular collection node that corresponds to the selected collection from the knowledge graph. Once identified, the particular collection node may be utilized to identify a set of digital assets that are associated with the particular collection node, and thus, the collection of related digital assets itself.

At block 112, the digital asset management module 102 may determine a subset of digital assets from the set of digital assets associated with the collection of related digital assets. By way of example, a subset of photos may be identified based at least in part on capture times of the respective photos in the subset. As a non-limiting example, photos that were captured within a 60 second time period, or a 90 second time period, within the same week, or month, may be identified. Any suitable time period duration may be utilized. For example, the set of digital assets 116 may include photos that were taken at a particular location (e.g., the user's home) on a particular day. In some embodiments, a subset of photos 118 may be identified from the set of digital assets 116 based at least in part on the capture times of the subset of photos 118 being within a five minute time period on the given day. This is not meant in the restrictive sense. The set of digital assets 116 may instead be taken over a longer period of time (e.g., a month, a year, etc.) or a shorter period of time (e.g., two hours, 30 minutes, etc.). In any case, the subset of photos 118 may be captured over a shorter period of time than the time utilized to capture the set of digital assets 116.

At block 120, the digital asset management module 102 may identify semantically similar digital assets within the subset of photos 118. The term “semantically similar” is used to describe a degree of similarity (e.g., over a threshold amount, under a threshold amount, etc.) between the content of at least two digital assets. By way of example, the digital asset management module 102 may generate content metadata 122 for each photo of the subset of photos 118. “Content metadata” of each photo may include any suitable number (e.g., 100, 1500, 15000, etc.) of confidence scores. Each confidence score may quantify a likelihood that a particular feature (e.g., one or more objects and/or one or more characteristics) appears in the photo. In some embodiments, the digital asset management module 102 may utilize a neural network to generate the content metadata for each digital asset. A neural network may be trained (e.g., by the digital asset management module 102 and/or another system) to receive a digital asset as input and to output the content metadata (e.g., any suitable number of confidence scores, indicators, or the like) for the provided digital asset. As a non-limiting example, the neural network may be trained using previously-captured photos for which content depicted within the photo is known. For example, a number of previously-captured photos may be known to include one or more cars. These photos may be used to train the neural network to analyze a digital asset and quantify a likelihood that one or more cars appear in a digital asset. In some embodiments, confidence scores may be provided to indicate the likelihood a particular feature is included within the digital asset. However, it is also contemplated that a Boolean value or other indicator may be utilized to identify that either 1) the feature is included in the digital asset, or 2) the feature is not included in the digital asset.

Once content metadata 122 is generated for each of the photos within the subset of photos 118, content metadata of one photo can be compared with content metadata of one or more of the remaining photos in the subset of photos 118. In some embodiments, the digital asset management module 102 may be configured to calculate a difference value that quantifies a degree of similarity between content metadata of a first photo and content metadata of a second photo. If the difference value is less than a threshold value, the digital asset management module 102 may determine that the two photos are semantically similar. In some cases, more than two photos of the subset of photos 118 can be determined to be semantically similar to one another.

At block 124, the digital asset management module 102 may generate a filtered set of digital assets (a filtered set of photos in this example). As a non-limiting example, the digital asset management module 102 may select (e.g., randomly, the first photo, the last photo, etc.) one photo (or more) from the set of semantically similar photos to include in the filtered set of digital assets. In some examples, the digital asset management module 102 may select a photo at random from the set of semantically similar photos to be included in the filtered set. Alternatively, in some embodiments the digital asset management module 102 may calculate, or otherwise obtain, aesthetic scores associated with each digital asset of the digital assets in the subset of photos 118 and utilize the aesthetic scores to determine which photo(s) are to be included in the filtered set. An aesthetic score, as used herein, may quantify a quality of the content included in the digital asset. Various pre-determined rules may be employed to calculate an aesthetic score and the calculation may be performed by the digital asset management module 102 or another system. In some examples, an aesthetic score for a digital asset (e.g., a photo) may be between 0 and 1, where 0 indicates the lowest aesthetic score and 1 the highest, although any suitable range or scoring paradigm may be employed. As a non-limiting example, a photo in which the whole of the photo is in focus may be associated with a higher aesthetic score (e.g., 0.90) than a photo in which most of the features of the photo are blurred. As another example, consider the case in which a photo includes a primary subject such as a person, animal, object, or the like, and the primary object is in focus while the rest of the photo is blurred. In this case, the photo may be associated with a higher aesthetic score (e.g., 0.95) than other photos in which the whole of the photo is in focus. Any suitable number of pre-determined rules may be utilized to calculate the aesthetic score based at least in part on color(s), lighting, exposure, focus, relative size of objects within the photo, arrangement, spacing, or any suitable attributes of the content of the photo.

As a specific example, photos 1-6 may be identified as the subset of photos 118. Content metadata 122 may be generated for each of the subset of photos 118. Through a comparison (e.g., calculating distance values) between pairs of content metadata of the subset of photos 118, the digital asset management module 102 may identify that photo 1, photo 2, and photo 5 are semantically similar. Accordingly, the digital asset management module 102 may determine (e.g., based on the aesthetic scores for photos 1, 2, and 5, randomly, etc.) that photo 2 is to be included in the filtered set of digital assets 126, while photo 1 and photo 5 are excluded. Separately, the digital asset management module 102 may determine that photos 3, 4, and 6 are semantically different from each other as well as photo 2. Accordingly, the digital asset management module 102 may generate the filtered set of digital assets 126 to include photos 2, 3, 4, and 6.

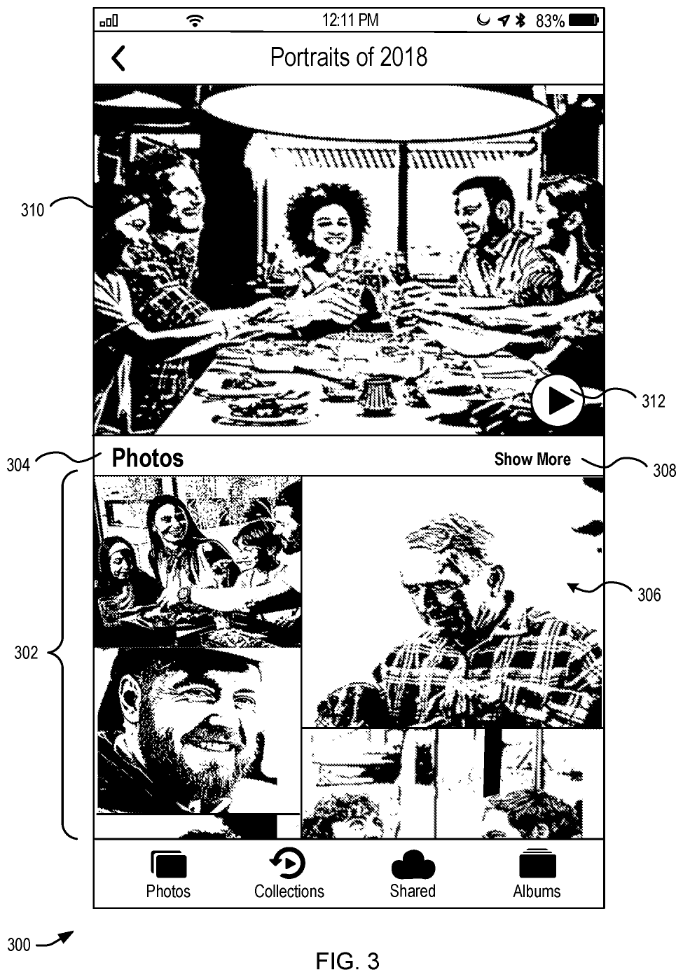

At block 128, the filtered set of digital assets 126 may be presented by the digital asset management module 102. By way of example, the filtered set of digital assets 126 may be provided via a user interface 130 provided by the user device 104. An example of the user interface 130 may be described in more detail below in connection with FIG. 3

FIG. 2 illustrates an example user interface 200 for enabling selection of a collection of related digital assets, in accordance with at least one embodiment. The user interface 200 may be an example of the user interface 108 of FIG. 1. In some embodiments, the user interface 200 may be provided as part of a digital asset management application operating on a user device (e.g., the user device 104 of FIG. 1). Although depicted in FIG. 2 as being a smartphone, the user device employed may be any suitable user device including, but not limited to, a laptop computer, a desktop computer, a tablet computing device, a wearable user device such a smartwatch, or the like.

In some embodiments, the user interface 200 may be presented in response to receiving a selection indicating that a collections tab 202 was selected. The user interface 200 enables selection of one or more collections of related digital assets utilizing one or more collection selection elements. A “collection” may be associated with a set of digital assets that each relate to one another temporally and/or geographically. In some embodiments, the user interface 200 depicts (at least partially) two collection selection elements (e.g., collection selection element 204 and collection selection element 206). It should be appreciated that any suitable number of collection selection elements may be provided within the user interface 200 in any suitable size and/or arrangement. In the example provided in FIG. 2, the user may scroll vertically (e.g., upward and/or downward) to peruse through any suitable number of collection event selection elements.

A collection selection element may be depicted as shown in FIG. 2 or the collection selection element may be provided in a different format. By way of example, as depicted in FIG. 2, the collection selection elements 204 and 206 appear as relatively large (with respect to the display 205) multimedia icons. For example, the collection selection element 204 may be provided by a multimedia icon that depicts a representative digital asset (e.g., a photo, a video, etc.) of the digital assets associated with the collection that corresponds to the collection selection element 204. By way of example, photo 208 may be provided as a multimedia icon for use as the collection selection element 204 for a particular collection (e.g., “Portraits of 2018”). Similarly, photo 210 may be provided as a multimedia icon for use as a collection selection element 206. In other examples, collection selection elements may be textual (e.g., a selection box and/or radio button located adjacent to text describing the collection). In still further examples, collection selection elements may include a collage of multiple digital assets associated with the collection. Numerous and varying manners of providing a list of collections of related digital assets from which a user may select one or more collections are contemplated.

In at least one embodiment, a collection selection element (e.g., the collection selection element 204) may include a collection identifier (e.g., collection identifier 207) that identifies the collection of related digital assets. In the example depicted in FIG. 2, two collections are identified, specifically, “Portraits of 2018” and “Birthday—Mar. 17, 2018.” In some embodiments, the collection identifier 207 (or any suitable collection identifier) may be determined by the digital asset management module 102 of FIG. 1 when a collection node is generated in the knowledge graph described herein. Additional information on the generation of moments can be found in U.S. patent application Ser. No. 15,391,276, filed Dec., 27, 2016, entitled “Knowledge Graph Metadata Network Based on Notable Moments,” which is incorporated by reference in its entirety and for all purposes. It should be appreciated that the processes for generating “moments” described in the aforementioned patent application may be equally applied to the generation of “collections” (otherwise referred to as “collection of related digital assets”) within the current disclosure.

In at least one embodiment, the collection identifier may be determined by identifying at least one common attribute shared by the digital assets associated with the collection node (and consequently, the collection). By way of example, a set of photos may be identified with an identifier “Portraits of 2018” based at least in part on determining (e.g., from the knowledge graph) that the digital assets associated with the collection were all captured on a date that occurred on or between Jan. 1, 2018 and Dec. 31, 2018 and that all of the images include one or more faces within the image. The collection identifier 209, “Birthday Mar. 17, 2017” may be identified based at least in part on determining (e.g., using the knowledge graph) that a set of digital assets were taken at approximately the same location, within a two-hour period of time, and that over a threshold number of images of the set include features associated with a birthday (e.g., candles, cake, party hats, presents, etc.). The identifier may be situated in any suitable manner within, or adjacent to, a collection selection element. In some embodiments, a collection identifier need not be utilized as a representative photo alone may be used to distinguish one collection from another.

Thus, when a user selects the collections tab 202, the digital asset management module 102 of FIG. 1 may be configured to obtain information related to one or more collections. As a non-limiting example, the digital asset management module 102 may utilize the knowledge graph to identify all (or some suitable number such as 20, 50, 100, etc.) collection nodes within the graph. Once identified, the digital asset management module 102 may utilize metadata associated with each of the collection nodes to identify a set of digital images with the digital image collection stored at the user device. In some embodiments, the collection node may identify a particular digital asset to be utilized for a collection selection element. For example, the collection node of the knowledge graph may identify image 208 as being a representative image to be provided with the collection selection element 204. In other embodiments, the digital asset management module 102 may randomly identify a particular digital asset to be utilized with a collection selection element. The digital asset management module 102 may present any suitable number of the collections in any suitable order and may enable the user to navigate through a list of such collections. In the example depicted in FIG. 2, the user (e.g., via a touch interface of the display 205) may swipe upward to scroll down through a list of multimedia icons depicting various collections. The user may select a collection selection element (e.g., the collection selection element 204) to select a particular collection. Upon selecting the particular collection, the user may be presented with the user interface 300 of FIG. 3.

FIG. 3 illustrates another example user interface 300 for providing a filtered set of digital assets associated with a particular collection of related digital assets, in accordance with at least one embodiment. Continuing with the example discussed above in connection with FIG. 2, upon selected a particular collection selection element (e.g., the collection selection element 204), the user may be presented with the user interface 300. The user interface 300 may correspond to a collection page associated with a particular collection.

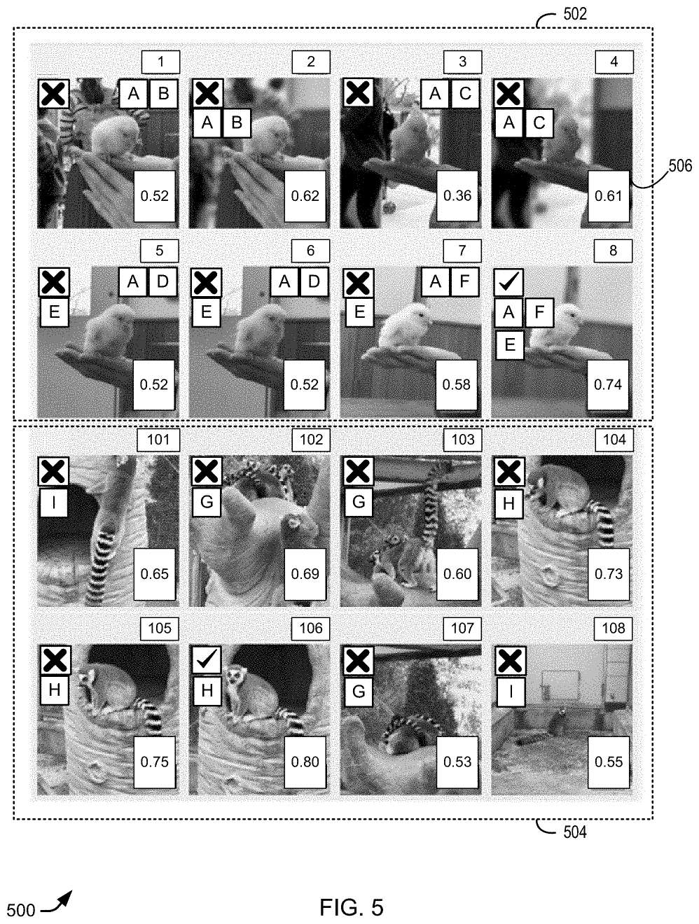

In some embodiments, a subset of digital assets 302 associated with the collection may be presented in the collection page depicted by user interface 300. The subset of digital assets 302 may be reduced set of digital assets associated with the collection that may not include every digital asset associated with the collection of related digital assets. As a non-limiting example, the knowledge graph may identify 50 images associated with a collection. However, the digital asset management module 102 may generate a filtered set of digital assets (e.g., the subset of digital assets 302) which includes only 15 of the images of the 50 images associated with the collection. Various processes for determining particular digital assets to include in the subset of digital assets 302 may be described in further detail in connection with FIGS. 5-9.

The subset of digital assets 302 may be arranged in any suitable manner. In the example depicted in FIG. 3, the subset of digital assets 302 may be provided under a heading 304 that identifies the digital assets as photos. FIG. 3 depicts the subset of digital assets 302 as being presented as a photo collage where the photos of the subset may vary in size. In some embodiments, the subset of digital assets 302 may be perused by swiping upward or downward which may execute a scrolling action. Although not depicted, the user interface 300 may include a scroll bar or other suitable navigational interface element (e.g., a slider, a “next photo page” link, or the like) for navigating through the subset of digital assets 302.

In some embodiments, a particular digital asset may be selected from the subset of digital assets 302. If selected, an enlarged view of the digital asset may be displayed. For example, if the digital asset 306 (or an icon representing the digital asset 306) were selected, the digital asset 306 may be provided in a full screen view (or an enlarged version of the digital asset 306 may be overlaid over the remaining elements of the user interface 300). The enlarged version of the digital asset may be presented with navigational elements (not depicted) that enable the user to navigate to a next enlarged digital asset (or previous enlarged digital asset) of the subset of digital assets 302. In some embodiments, a navigational element may be provided with the enlarged version of the digital asset to enable the user to exit out of the view and return to viewing the subset of digital assets as depicted in FIG. 3.

In at least one embodiment, a “show more” selection element 308 is provided within the user interface 300. Upon receiving an indication that the user has selected the “show more” selection element 308, the digital asset management module 102 of FIG. 1 may be configured to provide additional digital assets associated with the collection of related digital assets that were not included in the reduced set of digital images initially presented. That is, even though the subset of digital assets 302 may represent a reduced set of digital images associated with the collection, at least one previously filtered image may be presented upon selection of the “show more” selection element 308. In some embodiments, selection of the “show more” selection element 308 may cause all of the digital assets associated with the collection to be displayed, whereas in other embodiments, the digital asset management module 102 may selectively provide additional digital assets that were previously excluded from the subset of digital assets 302.

In some embodiments, the user interface 300 may present a video 310. Video 310 may include a compilation of all (or any suitable number) of the digital assets associated with the selected collection. In some embodiments the video 310 may be automatically played as soon as the user interface 300 is displayed. As a non-limiting example, the video 310 may cycle through any or all of the subset of digital assets 302 at a predetermined speed, in a predetermined order.

In some embodiments, the video 310 may not be automatically played, but a play option 312 may be provided that, upon selection, may play the video 310 at the predetermined speed. If the video 310 is being played, the play option 312 may be modified to provide a “pause” option (not depicted) that allows playback of the video 310 to be paused.

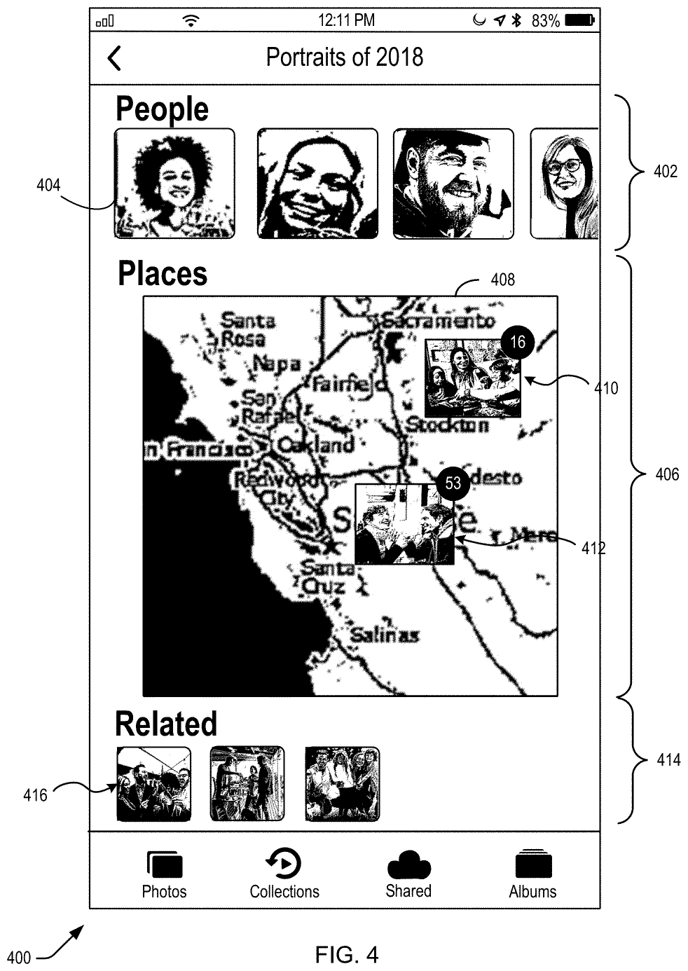

FIG. 4 illustrates additional user interface elements for presenting content related to a filtered set of digital assets associated with a particular collection of related digital assets, in accordance with at least one embodiment. The additional user interface elements may be presented via user interface 400. In some embodiments, the user interface 400 may be the same user interface as the user interface 300 of FIG. 3. By way of example, were the user to scroll downward through the subset of digital assets 302 of FIG. 3, the user interface elements may eventually be presented (e.g., at a bottom of the collection page associated with the selected collection).

The user interface 400 may include section 402. In some embodiments, section 402 of the user interface 400 may include one or more multimedia icons that individually represent a person that appears in at least one digital asset of the currently viewed digital assets associated with the collection. For example, the multimedia icon 404 (e.g., depicting person A) may be presented in section 402 because person A is determined to be present within at least one digital asset currently associated with the collection. In some cases, person A may be included in the subset of digital assets 302. In other embodiments, for example, when the “show more” selection element 308 has been selected and additional digital assets have been presented, multimedia icon 404 may be provided because person A has been identified within the currently displayed digital assets of the collection. Thus, it may be the case that some of the multimedia icons depicted in FIG. 4 may appear or disappear from the section 402 as more or less images are presented for the collection, depending on which people appear in the current set of digital assets being presented.

In at least one embodiment, the multimedia icon 404 may be selected to present a different set of digital images. By way of example, the digital asset management module 102 may receive indication that the multimedia icon 404 (e.g., representing person A) has been selected. Accordingly, the digital asset management module 102 may be configured to identify (e.g., utilizing the knowledge graph) other digital assets of the digital asset collection in which person A appears. Upon selecting multimedia icon 404, a set of images that each individually depict person A may be provided via another user interface (not depicted).

In at least one embodiment, the user interface 400 may include section 406. Location information associated with the digital assets of the collection may be provided. By way of example, the digital assets currently provided within the user interface 400, although not necessarily currently visible, may individually correspond to a particular location (e.g., a capture location). The capture location may be obtained by the digital asset management module 102 and analyzed to identify a map 408 with which to indicate the location information within section 406.

As a non-limiting example, the digital asset management module 102 may utilize the knowledge graph to identify that 16 images associated with the collection were taken around a location corresponding to the location icon 410, while 53 of the digital assets of the collection were captured around a location corresponding to the location icon 412. Each location icon can present a representative photo (or other digital asset) related to a particular location. A location represented by a location icon may a particular location (e.g., GPS coordinate, a place such as a park, a restaurant, or the like) or the location icon can represent a larger area such as locations within a given range (e.g., 5 miles) of a particular focal point (e.g., GPS coordinate). Upon selecting a location icon (e.g., the location icon 410), digital assets (e.g., photos) which correspond to the location icon may be displayed. Thus, if location icon 410 were selected, the 16 photos associated with the location represented by location icon 410 may be provided. In some cases, the 16 photos provided may be grouped based on more granular location identifiers. For example, 8 of the photos could correspond to a city A and the other 8 photos may correspond to city B, where city A and city B are initially represented by location icon 410. If the location icon 410 is selected, the 8 photos may be provided in a section identified as being related to city A, while the remaining photos may be provided in a section identified as being related to city B.

In at least one embodiment, the user interface 400 may include section 414. Section 414 may present one or more multimedia icons that individually represent a related collection. As a non-limiting example, the digital asset management module 102 of FIG. 1 may be configured to identify one or more collections that may relate to the “Portraits of 2018” collection currently being viewed. In some embodiments, the knowledge graph may be utilized to identify related collections (e.g., collection nodes) that share at least one common attribute as the currently selected collection. The digital asset management module 102 may present a multimedia icon for each identified related collection. By way of example, a related collection may be identified a multimedia icon 416 may be provided to enable selection of the related collection. In some examples, the related collection may be identified as being related to the currently select “Portraits of 2018” collection because at least one person included in a digital asset of the “Portraits of 2018” collection also appears in a digital asset associated with the related collection corresponding to the multimedia icon 416. As another example, the multimedia icon 416 may correspond to a collection that is related to the “Portraits of 2018” collection due to geographical distance (e.g., within 10 miles of the location(s) associated with the digital assets of the “Portraits of 2018” collection). As yet another example, the multimedia icon 416 may correspond to a collection that is related by content to the “Portraits of 2018” collection. That is, the multimedia icon 416 may correspond to other portraits, perhaps taken in another year (e.g., 2017) and/or over a same or different time period (e.g., Portraits of Spring 2018, Portraits of January 2018, etc.).

FIG. 5 illustrates an example process of generating a filtered set of digital assets related to a collection of related digital assets, in accordance with at least one embodiment. Images 1-8 and 101-108 may each be associated with a selected collection (e.g., Zoo Day 2017).

The images 1-8 may be grouped in subset 502 and the images 101-108 may be grouped in subset 504 by the digital asset management module 102 of FIG. 1 based at least in part on capture times. For example, the images 1-8, and separately the images 101-108, may have been captured within a particular time period (e.g., a 90-second time period). Although images (e.g., digital photos) are utilized for illustration, the same process described in FIG. 5 may be utilized for any suitable digital asset (e.g., a digital video).

In accordance with at least one embodiment, content metadata may be generated for each of the images 1-8 in subset 502. The content metadata for each image may include a number of confidence scores that indicate a likelihood that a particular feature appears in the digital asset. By way of example, the content metadata for images 1-8 may indicate that a feature (e.g., corresponding to the bird) likely (e.g., over a threshold value such as 0.5 indicating more likely than not) appears in each image. However, the content metadata for photo 1 may also indicate a relatively high likelihood that the image also contains a backpack, while the content for photo 3 may indicate a relatively high likelihood that a person appears in the image.

The digital asset management module 102 of FIG. 1 may be configured to analyze and determine a degree of semantical similarities between the images 1-8 based at least in part on the images respective content metadata. In some embodiments, images 1-8 may be determined to be semantically similar to some degree (as indicated by “A”) due to a determination that each image shares at least one feature (e.g., they each include a bird). However, additional similarities may be determined between images based on content metadata. For example, photos 1 and 2 may be considered to be more semantically similar (as indicated by “B”) to one another than other images in the subset 502 based at least in part on a determination that two hands appear in the picture. Similarly, photos 3 and 4 may be considered to be most similar with one another (as indicated by “C”). Images 5-8 may be considered to be, to some degree, semantically similar to one another, while photos 5 and 6 may be determined to be more similar to one another than other images of the subset 502 (as indicated by “E”) and images 7 and 9 may be determined to be more similar to one another than other images of the subset 502 (as indicated by “F”).

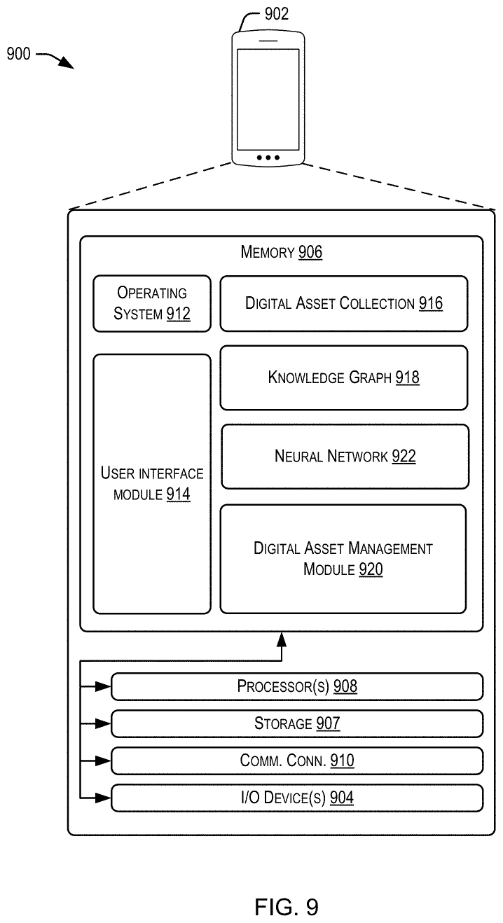

In some embodiments, the digital asset management module 102 may be configured to obtain and/or calculate an aesthetic score for each semantically similar image. By way of example, image 4 has an aesthetic score 506 of 0.61. Calculating an aesthetic score may be discussed in further detail with respect to FIG. 9. In some embodiments, the aesthetic score may be obtained from a knowledge graph or otherwise ascertainable by the digital asset management module 102.

In some embodiments, the digital asset management module 102 may be configured to select a single image from the subset 502 to be included in a filtered set. According to these embodiments, the digital asset management module 102 may select one of the images from the subset 502. By way of example, image 8 may be selected for inclusion in the filtered set based at least in part on a number of similarities found between image 8 and other images of the subset (as indicated by A, F, and E) and/or based at least in part on the aesthetic score of image 8 being higher than the respective aesthetic scores of images 1-7.

In other embodiments, the digital asset management module 102 may be configured to include a greater number of images in the filtered set (e.g., the set eventually provided in response to user input selecting the collection). Thus, in some embodiments, the digital asset management module 102 may select photo 2, photo 4, photo 5 or 6, and photo 8 as the images to include in a filtered set. It could be the case that the digital asset management module 102 creates both filtered sets (e.g., a filtered set containing image 8, and a filtered set containing photos 2, 4, 6, and 8. In some embodiments, the filtered set containing image 8 may be presented upon selection of the collection, while the filtered set containing photos 2, 4, 6, and 8 may be presented should the user select the “show more” selection element 308 of FIG. 3.

The digital asset management module 102 of FIG. 1 may similarly analyze subset 504 to determine semantical similarities between the images 101-108 based at least in part on the images respective content metadata. Semantical similarities between the images 101-108 may be illustrated by “G,” “H,” and “I.” Depending on a degree by which the subsets 502 and 504 are to be filtered, the digital asset management module 102 may identify a single image (e.g., image 106) based at least in part on a highest aesthetic score (e.g., 0.80). However, in some embodiments, the digital asset management module 102 may determine multiple images to be include in the filtered set. For example, images 101, 102 and 106 may be selected for inclusion in a filtered set based at least in part on the semantical similarities between the images as indicated by “G,” “H,” and “I,” and the images' respective aesthetic scores.

Accordingly, the digital asset management module 102 may select image 8 and image 106 to be included in a filtered set provided in response to receiving an indication of a collection selection corresponding to the collection “Zoo Day 2017.” At a subsequent time, the user may select an interface element similar to the “show more” selection element 308 of FIG. 3. Upon selecting such an interface element, the digital asset management module 102 may be configured to provide a different filtered set that includes photos 2, 4, 6, 8, 101, 102, and 106.

The example provided in FIG. 5 is intended to be illustrative in nature and is not intended to limit the scope of this disclosure. Any suitable number of subsets may be formed within a set of digital assets. Any suitable number of digital assets may be filtered from each subset based at least in part on comparing content metadata associated with respective digital assets and/or based on aesthetic scores of the respective digital assets.

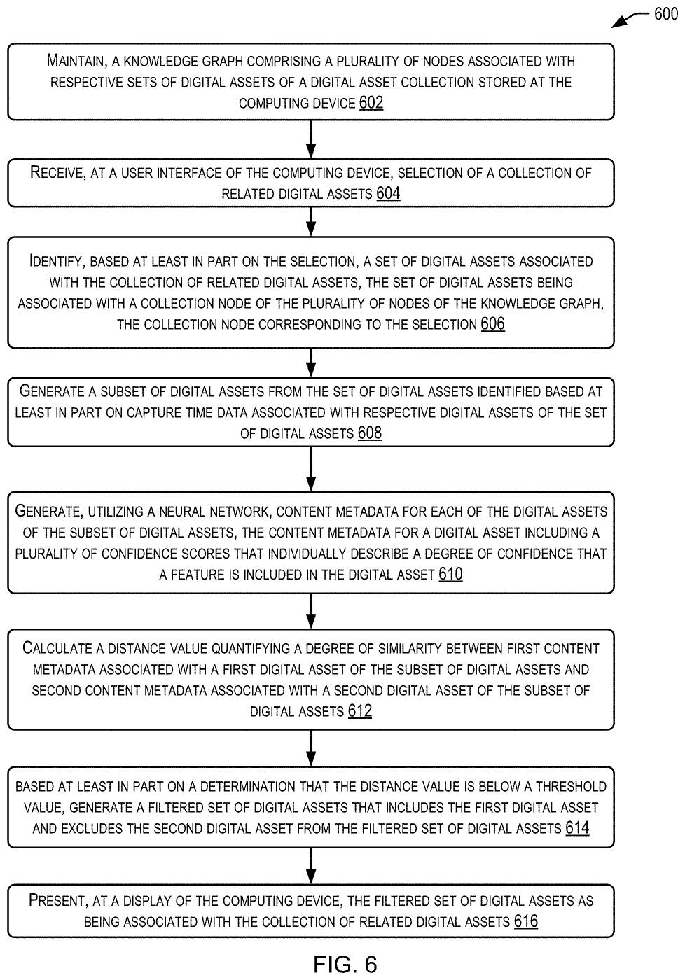

FIG. 6 is a flow diagram to illustrate a method 600 for generating a filtered set of digital assets associated with a collection of related digital assets, in accordance with at least one embodiment. The method 600 may, in some embodiments, be performed by the digital asset management module 102 of FIG. 1 and/or the digital asset management module 920 of FIG. 9. The steps of method 600 may be executed in any suitable order and more or fewer operations may be included in the method 600 regardless of the operations specifically depicted in FIG. 6.

The method 600 may begin at 602, where a knowledge graph (e.g., the knowledge graph 918 of FIG. 9) may be maintained by one or more processors of a computing device (e.g., the user device 104 of FIG. 1, the computing device 902 of FIG. 9, etc.). In some embodiments, the knowledge graph may comprise a plurality of nodes associated with respective sets of digital assets of a digital asset collection (e.g., the digital asset collection 916 of FIG. 9) stored at the computing device (e.g., within memory 906 of FIG. 9).

At 604, a selection of a collection of related digital assets may be received at a user interface (e.g., the user interface 200 of FIG. 2) of the computing device. In some embodiments, the selection may be received by the user interface module 914 of FIG. 9 and provided to the digital asset management module 920. The collection may correspond to a particular collection node of the knowledge graph. The particular collection node (and consequently the collection itself) may be associated with a set of related digital assets of the digital asset collection 916.

At 606, a set of digital assets associated with the collection of related digital assets may be identified by the one or more processors based at least in part on the collection selected. In some embodiments, the set of digital assets may be associated with the collection node of the plurality of nodes of the knowledge graph and the collection node may correspond to the collection selected at 604.

At 608, a subset of digital assets may be generated by the one or more processors of the computing device 902. By way of example, the subset of digital assets may be generated from the set of digital assets identified at 604 based at least in part on capture time data associated with respective digital assets of the set of digital assets. That is, the set of digital assets associated with the collection node may be grouped into any suitable number of subsets based at least in part on a capture time of each digital asset. Thus, images that occur within a given time period (e.g., a 90-second time period, a 2-minute time period, etc.) may be grouped in a particular subset, while other digital assets that were captured in a different time period may be included in a different subset.

At 610, content metadata for each of the digital assets of the subset of digital assets may be generated by the one or more processors utilizing a neural network (e.g., the neural network 922 of FIG. 9). The neural network may be described in more detail in connection with FIG. 9. The neural network may be configured to accept a digital asset as input and provide as output content metadata of the digital asset. The content metadata for a digital asset may include a plurality of confidence scores that individually describe a degree of confidence that a feature (e.g., an object, a characteristic, or one or more objects and/or characteristics) is included in the digital asset (e.g., appears in the digital asset).

At 612, a distance value may be calculated by the one or more processors. The distance value may quantify a degree of similarity (e.g., semantical similarity) between first content metadata associated with a first digital asset of the subset of digital assets and second content metadata associated with a second digital asset of the subset of digital assets. Said another way, the content metadata may be compared to determine a degree to which the content of the first and second digital assets are similar, regardless of the arrangement of the particular features within each digital asset.

At 614, based at least in part on a determination that the distance value is below a threshold value, a filtered set of digital assets may be generated (e.g., by the digital asset management module 102 and/or 920) that includes the first digital asset and excludes the second digital asset from the filtered set of digital assets.

At 616, the filtered set of digital assets may be presented (e.g., by the user interface module 914) at a user interface of the computing device as being associated with the collection (based at least in part on the collection selected as indicated at 604).

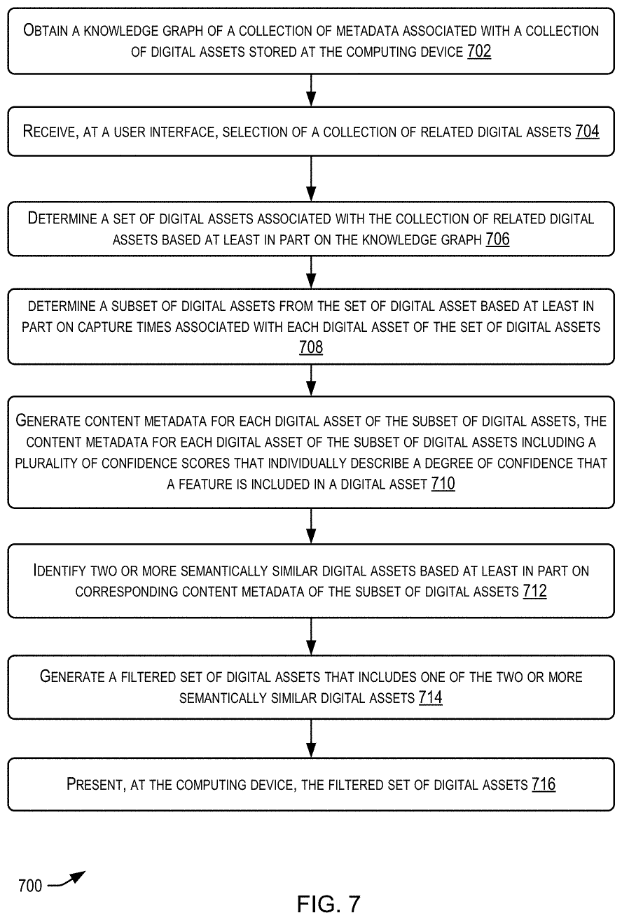

FIG. 7 is another flow diagram to illustrate a method 700 for generating a filtered set of digital assets associated with a collection of related digital assets, in accordance with at least one embodiment. The method 700 may be performed by a computing device (e.g., the computing device 902 of FIG. 9) which may comprise one or more memories and one or more processors in communication with the one or more memories and configured to execute instructions stored in the one or more memories to cause the computing device to perform operations the operations described. The operations of method 700 may be performed in any suitable order and, in some embodiments, more or fewer operations may be performed as part of the method 700.

The method 700 may begin at 702, where a knowledge graph (e.g., the knowledge graph 918 of FIG. 9) may be obtained (e.g., by the digital asset management module 920 of FIG. 9). The knowledge graph may include a collection of metadata associated with a collection of digital assets stored at the computing device (e.g., metadata associated with the digital assets of the digital asset collection 916 of FIG. 9).

At 704, a selection of a collection of related digital assets may be received at a user interface of the computing device. By way of example, a selection of a collection may be received at the user interface 200 of FIG. 2 provided by the user interface module 914 of FIG. 9.

The user interface module 914 may receive the selection and may forward the selection (or information regarding the selection) to the digital asset management module 920.

At 706, a set of digital assets associated with the collection of related digital assets may be determined (e.g., by the digital asset management module 920) based at least in part on the knowledge graph (e.g., the knowledge graph 918. As a non-limiting example, the digital asset management module 920 may consult the knowledge graph 918 to identify a collection node which corresponds to the collection selection received at 704. Once identified, the collection node may be utilized to identify a set of digital assets from the digital asset collection 916 which are associated with the collection selected.

At 708, a subset of digital assets may be determined (e.g., by the digital asset management module 920) from the set of digital assets based at least in part on capture times associated with each asset of the set of digital assets. Said another way, the set of digital assets associated with the collection node may be grouped into any suitable number of subsets based at least in part on a capture time of each digital asset of the set. Thus, digital assets that were captured within a given time period (e.g., a 90-second time period, a 2-minute time period, etc.)

may be grouped in a particular subset, while other digital assets that were captured in a different time period may be included in a different subset.

At 710, content metadata may be generated (e.g., by the digital asset management module 920) for each digital asset of the subset of digital assets. In some embodiments, the content metadata for each digital asset of the subset of digital assets may include a plurality of confidence scores that individually describe a degree of confidence that a feature is included in a digital asset.

At 712, two or more semantically similar digital assets may be identified (e.g., by the digital asset management module 920) based at least in part on corresponding content metadata of the subset of digital assets. As described throughout, a distance value may be calculated using two instances of content metadata. The distance value may quantify a degree of similarity between the content of the respective digital assets. In some embodiments, the distance value may quantify a degree by which the content of the digital assets differ. In either scenario, the distance value may be utilized to determine that two digital assets include content which may be considered to be semantically similar to some degree. As a non-limiting example, a distance value under a threshold value may indicate that the content of the digital assets are semantically similar.

At 714, a filtered set of digital assets may be generated (e.g., by the digital asset management module 920) that includes one of the two or more semantically similar digital assets. As discussed above with respect to FIG. 5, particular digital assets of a subset may be selected for inclusion in the filtered set based at least in part on the distance values and, in some cases, an aesthetic score associated with the respective digital assets of the subset.

At 716, the filtered set of digital assets may be presented at a user interface (e.g., the user interface 200 of FIG. 2).

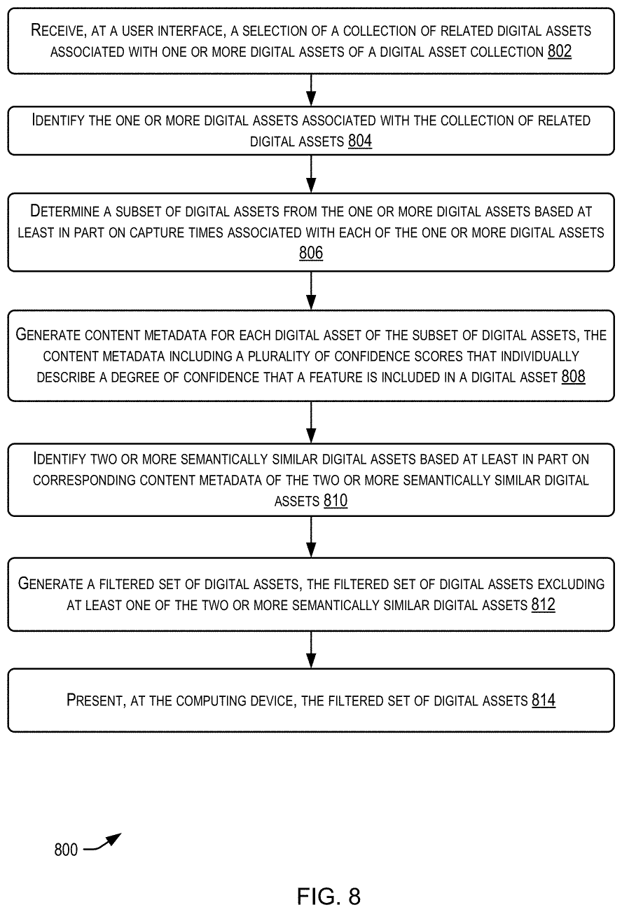

FIG. 8 is yet another flow diagram to illustrate a method 800 for generating a filtered set of digital assets associated with a collection of related digital assets, in accordance with at least one embodiment. The method 800 may be performed by one or more processors (e.g., the processors 908 of FIG. 9) executing instructions stored in a computer-readable medium (e.g., a computer-readable storage medium such as memory 906 of FIG. 9). The operations of method 800 may be performed in any suitable order and, in some embodiments, more or fewer operations may be performed as part of the method 800.

The method 800 may begin at 802, a selection of a collection of related digital assets may be received (e.g., by the user interface module 914 of FIG. 9) at a user interface (e.g., the user interface 200). The collection of related digital assets may be associated with one or more digital assets of a digital asset collection (e.g., the digital asset collection 916 of FIG. 9).

At 804, the one or more digital assets associated with the collection of related digital assets may be identified (e.g., by the digital asset management module 920). For example, the digital asset management module 920 may consult the knowledge graph 918 to identify a collection node corresponding to the selection. Once identified, the collection node may be utilized to identify the one or more digital asset associated with the collection of related digital assets.

At 806, a subset of digital assets may be identified from the one or more digital assets based at least in part on capture times associated with each asset of the one or more digital assets. As a non-limiting example, the digital asset management module 920 may be configured to group digital assets of the one or more digital assets into one or more subset based at least in part on determining that capture time of each digital asset. Thus, digital assets captured with a particular time period (e.g., a 90-second time period, a 120-second time period, etc.) may be grouped together in a particular subset.

At 808, content metadata may be generated (e.g., by the digital asset management module 920) for each digital asset of the subset of digital assets. In some embodiments, the content metadata may include a plurality of confidence scores that individually describe a degree of confidence that a feature is included in a digital asset. As described throughout, the digital asset management module 920 may utilize the neural network 922 of FIG. 9 to generate the content metadata for each digital asset (or at least two digital assets) of the subset.

At 810, two or more semantically similar digital assets may be identified (e.g., by the digital asset management module 920) based at least in part on corresponding content metadata of the two or more semantically similar digital assets. The content metadata may be compared and a number may be determined which may correspond to a number of common features that appear (over a threshold likelihood) within the two digital assets. In some embodiments, a distance value may be calculated that quantifies the degree of semantical similarity between the digital assets of the subset.

At 812, a filtered set of digital assets may be generated (e.g., by the digital asset management module 920). In some embodiments, the filtered set of digital assets may exclude at least one of the two or more semantically similar digital assets. Determinations as to which digital assets are to be selected for inclusion or exclusion in the filtered set is discussed in further detail above in connection with FIG. 5.

At 814, the filtered set of digital assets may be presented at a user interface (e.g., the user interface 200 of FIG. 2).

FIG. 9 is a simplified block diagram illustrating is a computer architecture 900 for providing filtered sets of digital assets as described herein, according to at least one embodiment. In some embodiments, computing device 902 (e.g., an example of the user device 104 of FIG. 1), having example architecture 900, may be configured to present relevant user interfaces, capture audio and video information, search digital asset collections, display user interfaces (e.g., the user interfaces 200, 300, and 400 of FIGS. 2, 3, and 4) on a display, receive haptic inputs, receive touch screen inputs, and perform logic.

Computing device 902 may be configured to execute or otherwise manage applications or instructions for performing the described techniques such as, but not limited to, providing a user interface (e.g., user interfaces 200-400 of FIGS. 2-4) for selecting a collection of related digital assets and perusing the digital assets and related data (e.g., multimedia icons for viewing related sets of digital assets) associated with the selected collection of related digital assets. Computing device 902 may receive inputs (e.g., utilizing I/O device(s) 904 such as at a touch screen, mouse, or other input device), capture information, process the information, and then present the digital assets also utilizing I/O device(s) 904 (e.g., a display of computing device 1302).

Computing device 902 may be any type of computing device such as, but not limited to, a mobile phone (e.g., a smartphone), a tablet computer, a personal digital assistant (PDA), a laptop computer, a desktop computer, a thin-client device, a smart watch, a wireless headset, or the like. The computing device 902 can be a portable multifunction device having a touch screen in accordance with some embodiments. The touch screen optionally displays one or more graphics within user interface (UI). In this embodiment, as well as others described below, a user is enabled to select one or more of the graphics by making a gesture on the graphics, for example, with one or more fingers or one or more styluses. In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with computing device 902. In some implementations or circumstances, inadvertent contact with a graphic does not select the graphic. For example, a swipe gesture that sweeps over a multimedia icon optionally does not select the corresponding application when the gesture corresponding to selection is a tap. Computing device 902 can optionally also include one or more physical buttons, such as “home” or menu button. As menu button is, optionally, used to navigate to any application in a set of applications that are, optionally executed on the computing device 902. Alternatively, in some embodiments, the menu button is implemented as a soft key in a GUI displayed on a touch screen.

In one embodiment, computing device 902 includes a touch screen, menu button, push button for powering the device on/off and locking the device, volume adjustment button(s), Subscriber Identity Module (SIM) card slot, head set jack, and docking/charging external port.

Push button is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, computing device 902 also accepts verbal input for activation or deactivation of some functions through microphone. Computing device 902 also, optionally, includes one or more contact intensity sensors for detecting intensity of contacts on a touch screen and/or one or more tactile output generators for generating tactile outputs for a user of computing device 902. In some embodiments, the I/O device(s) 904, may include a touch input device, a keyboard, a mouse, a pen, a voice input device, a display, a speaker, a printer, etc.

In one illustrative configuration, computing device 902 may include at least one memory 906 and one or more processing units (or processor(s)) 908. Processor(s) 908 may be implemented as appropriate in hardware, software, or combinations thereof. Computer-executable instruction or firmware implementations of processor(s) 908 may include computer-executable instructions written in any suitable programming language to perform the various functions described.

Memory 906 may store program instructions that are loadable and executable on processor(s) 908, as well as data generated during the execution of these programs. Depending on the configuration and type of computing device 902, memory 906 may be volatile (such as random access memory (RAM)) and/or non-volatile (such as read-only memory (ROM), flash memory, etc.). Computing device 902 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, memory 906 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

Memory 906 and additional storage 907, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. Memory 906 and additional storage 907 are both examples of non-transitory computer storage media. Additional types of computer storage media that may be present in computing device 902 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by computing device 902. Combinations of any of the above should also be included within the scope of non-transitory computer-readable storage media.

Alternatively, computer-readable communication media may include computer-readable instructions, program modules, or other data transmitted within a data signal, such as a carrier wave, or other transmission. However, as used herein, computer-readable storage media does not include computer-readable communication media.

Computing device 902 may also contain communications connection(s) 910 that allow computing device 902 to communicate with a data store, another computing device or server, user terminals and/or other devices via one or more networks. Such networks may include any one or a combination of many different types of networks, such as cable networks, the

Internet, wireless networks, cellular networks, satellite networks, other private and/or public networks, or any combination thereof

Turning to the contents of memory 906 in more detail, memory 906 may include operating system 912 and/or one or more application programs or services for implementing the features disclosed herein including the user interface module 914, the digital asset collection 916 the knowledge graph 918, and/or the digital asset management module 920 (e.g., the digital asset management module 102 of FIG. 1). Memory 906 may also be configured to store one or more audio and video files as digital assets in the digital asset collection 916 and the knowledge graph 918. Utilizing the digital asset collection 916 and the knowledge graph 918, the computing device 902 can perform all of the operations described herein.

In some examples, user interface module 914 may be configured to manage the user interface of computing device 902. For example, user interface module 914 may present any number of various UIs requested by computing device 902. In particular, user interface module 914 may be configured to present UIs 200-400 of FIGS. 2-4, which enables implementation of the features describe herein, specifically viewing various portions (e.g., collection of related digital assets) of the digital asset collection. User input received at the UIs 200-400 may be received by the user interface module 914, which in turn may stimulate (e.g., by executing one or more function calls, passing data such as an indication of a user interface selection, etc.) execution of functionality of the digital asset management module 920. The user interface module 914 may be configured to consult the knowledge graph 918 and/or access the digital asset collection 916 for any suitable purpose in the course of providing any suitable user interface described herein.

By way of example, the user interface module 914 may be configured to receive user input (e.g., from the user interface module 914). User input may include any suitable data related to selections and/or navigation received from the user at a user interface of the computing device 902. In some embodiments, the user interface module 914 may receive an indication that a particular collection has been selected by the user. In response, the user interface module 914 may provide the user input to the digital asset management module 920, which in turn may consult the knowledge graph 918 to obtain a set of digital assets associated with the selected collection. As another example, the user interface module 914 may receive an indication that a user interface element (e.g., the multimedia icon 404 of FIG. 4) has been selected. In response, the user interface module 914 may be configured to provide the user input to the digital asset management module 920 which in turn consults the knowledge graph 918 to identify a set of digital assets which are associated with the selected user interface element. For example, were the multimedia icon 404 to be selected, the digital asset management module 920 may consult the knowledge graph 918 to identify digital assets (e.g., photos) in which person A (associated with the multimedia icon 404) appears.

In some embodiments, the digital asset management module 920 may be configured to maintain and/or obtain information from the knowledge graph 918. As discussed above, the knowledge graph 918 may be stored in memory 906 and may include various nodes (e.g., metadata nodes, collection nodes, etc.) corresponding to digital asset metadata. Edges of the knowledge graph 918 may define various correlations between the nodes. In some embodiments, collection nodes of the knowledge graphs may be associated with one or more digital assets of the digital asset collection 916. The digital asset management module 920, through the analysis techniques described herein) may be configured to generate any suitable node and/or edge of the knowledge graph 918, although in some examples, the knowledge graph 918 may be maintained by another module or system and merely accessible to the digital asset management module 920.

Once a set of digital assets are identified (e.g., from the knowledge graph 918), the digital asset management module 920 may be configured to reduce the set (or generate a filtered set of the digital assets). By way of example, the digital asset management module 920 may be configured to group digital assets of the set of digital assets into subsets. In some embodiments, the digital asset management module 920 may group the digital assets into subsets based at least in part on capture times associated with the respective digital assets. Thus, a subset of digital assets may include digital assets that were captured within a 90-second time period (e.g., or a 5-minute time period, an hour long time period, etc.). Once grouped in these subsets, content metadata may be generated (e.g., by the digital asset management module 920) for at least two of the digital assets in the subset. In some embodiments, content metadata for each asset of the digital assets in the subset may be generated. As discussed above, content metadata of a digital asset may include any suitable number of confidence scores. Each confidence score may quantify a likelihood that a particular feature appear in the digital asset. Each feature may correspond to one or more objects (e.g., a ball, a tree, a car, a person, etc.) and/or one or more characteristics (e.g., a sunny day, a cloudy day, captured at a beach, etc.). In some embodiments, a confidence score may be between 0 and 1, where 0 indicates a 0% likelihood that the feature appears in the digital asset, while a 1 may indicate a 100% likelihood (e.g., certainty) that the feature appears in the digital asset. Any suitable number of confidence scores corresponding to any suitable number of features may be included in content metadata associated with a digital asset.

In some embodiments, the digital asset management module 920 may be configured to generate content metadata for any suitable digital asset at any suitable time. Although examples herein describe content metadata being generated after a set of digital assets are grouped into subsets based on capture times, these examples are non-limiting in nature. It is contemplated that the digital asset management module 920 may generate such content metadata at other times. For example, content metadata may be generated by one or more digital assets as part of managing the knowledge graph 918. Once content metadata is obtained, whenever it is obtained, the digital asset management module 920 may be configured to utilize the content metadata that identifies various features within the digital asset to label or otherwise categorize a corresponding digital asset. By way of example, if content metadata for a digital asset indicates a high degree of likelihood (e.g., a confidence score above a threshold value) that a particular feature (e.g., a dog) appears in the digital asset, the digital asset management module 920 may store a label/category such as “dog” as being associated with that digital asset. In some embodiments, the digital asset management module 920 may store such information in any suitable data store. In some embodiments, the digital asset management module 920 may store such labels/categories as part of the knowledge graph 918. For example, any node or metadata asset of the knowledge graph can be updated to indicate that the digital asset is associated with the label/category “dog.” Accordingly, it is contemplated that subsequent collections (e.g., collection nodes) may be generated based on the labels such that a new collection node may be generated that indicates all digital assets in the digital asset collection that are associated with the label/category “dog.” These labels may be utilized for any suitable purpose. For example, a user may search for digital assets using a keyword “dog” and the knowledge graph 918 may be utilized to return all the digital assets in the digital asset collection labeled with “dog.”

In some embodiments, the digital asset management module 920 may be configured to train neural network 922 for generating content metadata of a digital asset. By way of example, the digital asset management module 920 may utilize previously generated digital assets for which features are known in order to train a neural network 922. Through supervised learning techniques, for example, the neural network 922 may learn how to identify a particular set of features (e.g., features included in the provided digital assets) in order to identify similar features in subsequently provided digital assets. Accordingly, the neural network 922 may be configured to receive a digital asset and output the content metadata for the digital asset.

The digital asset management module 920 may submit each digital asset of the digital assets in a subset of digital assets (e.g., grouped by capture times) to the neural network 922 to obtain content metadata for each asset. In some embodiments, the digital asset management module 920 may compare or otherwise assess the similarity of the digital assets to one another using the respective content metadata. In some examples, the digital asset management module 920 may be configured to calculate a distance value (e.g., using any suitable distance algorithm) which quantifies a degree of differences between two instances of content metadata. The distance value may, in some examples, be within a range of 0 and 1, where 0 identifies no differences between the two instances of content metadata (e.g., identical content metadata) and 1 indicates that the two instances of content metadata are entirely different. In another embodiment, the distance value may quantify a degree of similarities in a range between 0 and 1 where 0 indicates no similarities and 1 indicates identical content metadata. These are merely an example, other distance values and/or ranges may be utilized in order to identify a degree of similarity between two instances of content metadata and would be apparent to one skilled in the art.

The digital asset management module 920 may be configured to determine whether or not the distance value is below a threshold value. By way of example, the digital asset management module 920 may store internal or access a global variable that indicates a threshold value such as 0.25. In some embodiments, the digital asset management module 920 may compare the distance value quantifying the similarities between content metadata A (e.g., associated with a first digital asset of the subset) and content metadata B (e.g., associated with a second digital asset of the subset). If the distance value is breaches (e.g., is less than, is greater than) the threshold value (e.g., indicating a high degree of similarities due to relatively few differences between the content metadata A and the content metadata B), the digital asset management module 920 may be configured to identify the first digital asset and the second digital asset as being semantically similar. As discussed above, the term “semantically similar” identifies digital assets as containing over a threshold number of similar features regardless of arrangement of such features with the digital assets. Thus, an image including a person and a car to the left of the person may be considered semantically similar to an image of the person (or another person) with a car that is located to the right of the person. As another simplistic example, an image that includes a beach and a dog and a tree, may be determined to be semantically similar to another image that includes a beach and a dog and a tree and a ball, regardless of the locations of each feature within the respective digital assets. Thus, unlike conventional system which may only identify images as being similar based on pixel-type comparison between images, the digital asset management module 920 is able to identify semantically similar images that contain content that is similar even if differently arranged. One two semantically similar images are identify, the digital asset management module 920 may be configured to utilize one (or both) content metadata for one (or both) semantically similar digital asset to identify other potentially semantically similar digital assets in the subset.

The digital asset management module 920 may be configured to obtain and/or calculate aesthetic scores for one or more digital assets. By way of example, the digital asset management module 920 may obtain aesthetic scores for each semantically similar digital asset in the subset. In some embodiments, an aesthetic score for a digital asset may quantify a degree of quality of the content of the digital asset. As described above, an image that is entirely blurred may receive a very low aesthetic score as the features of the image may not be viewable. The aesthetic score may be calculated using any suitable algorithm and/or rules that define when an image is to be considered aesthetic pleasing and when the image is to be considered aesthetic displeasing. Although not depicted, another neural network may be utilized to calculate the aesthetic score for a digital asset. This neural network can be trained with previously generated photos for which an aesthetic score has been assigned. Through such training, the neural network may be trained to receive a digital asset and output an aesthetic score for the digital asset.

In some embodiments, the digital asset management module 920 may be configured to select one or more semantically similar digital assets for inclusion in a filtered set of digital assets. In some examples, the digital asset management module 920 may include the first digital asset of the subset that is semantically similar to other digital assets of the subset (depending on an order of the subset of digital assets). As another example, the digital asset management module 920 may randomly select a digital asset of the semantically similar digital assets to include in the filtered set. In yet another example, the digital asset management module 920 may select a semantically similar digital asset with a highest aesthetic score to be included in the filtered set.

It should be appreciated that the digital asset management module 920 may store content metadata generated in the memory 906 (e.g., as part of the knowledge graph 918 or otherwise) for utilization in the future. It should also be appreciated that the digital asset management module 920 may not generate an instance of content metadata for every single digital asset in the initial set of digital assets identified by the knowledge graph. For example, a digital asset in the initial set may have been captured at a time that is not relatively near (e.g., within 90-second time period of) any other capture times. Accordingly, the digital asset management module 920 may refrain from generating content metadata for the digital asset. In other examples, the digital asset management module 920 may generate content metadata for every digital asset identified by the knowledge graph 918 as being related to the user's selection (e.g., related to a collection, related to a person, a place, related to a related collection, etc.).

Once a filtered set of digital assets has been generated by the digital asset management module 920, the filtered set may be provided to the user interface module 914 for display within a user interface (e.g., the user interfaces 200-400). Additional user input received at the user interfaces provided by the user interface module 914 may cause the displayed digital assets to be modified (e.g., based at least in part on processing the user input by the user interface module 914 and the digital asset management module 920).

The various embodiments further can be implemented in a wide variety of operating environments, which in some cases can include one or more user computers, computing devices, or processing devices which can be used to operate any of a number of applications. User or client devices can include any of a number of personal computers, such as desktop or laptop computers running an appropriate operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art (except for transitory media like carrier waves or the like) such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, as noted above, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

As described above, one aspect of the present technology is the collection and use of the user's personal information. The present disclosure contemplates that in some instances, this gathered data may include personal information data that uniquely identifies or can be used to contact or locate a specific person. The present disclosure recognizes that the use of such personal information data, in the present technology, can be used to the benefit of users. For example, the personal information can be used to identify collections, related collections, particular people, locations at which the digital assets were captured, etc. on behalf of the user from the user's digital asset collection. Such information may be utilized to provide the user a representative set of digital assets that provide the user with a general understanding of the activities conducted at the event without requiring the user to sift needlessly through every single digital asset captured at the event. Accordingly, the personal information collected may be utilized (in the manner described herein) to provide a more efficient and easier interface for presenting memories to the user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. Hence different privacy practices should be maintained for different personal data types in each country.

Despite the foregoing, the present disclosure also contemplates embodiments in which users selectively block the use of, or access to, personal information. That is, the present disclosure contemplates that hardware and/or software elements can be provided to prevent or block access to such personal information. For example, the present technology can be configured to allow users to select to “opt in” or “opt out” of participation in the collection of personal information (or some portion of their personal information) during registration for services (e.g., associated with the digital asset management module 920 of FIG. 9) or anytime thereafter. In another example, users can select not to provide personal information for the purposes of creating and presenting collections of related digital assets as described above. In yet another example, users can select to limit the length of time personal information is maintained or entirely prohibit the use of such personal information. In addition to providing “opt in” and “opt out” options, the present disclosure contemplates providing notifications relating to the access or use of personal information.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, data de-identification can be used to protect a user's privacy. De-identification may be facilitated, when appropriate, by removing specific identifiers, controlling the amount or specificity of data stored, controlling how data is stored, and/or other methods.

Therefore, although the present disclosure broadly covers use of personal information data to implement one or more various disclosed embodiments, the present disclosure also contemplates that the various embodiments can also be implemented without the need for accessing such personal information data.

The use of the terms “a,” “an,” and “the,” and similar referents in the context of describing the disclosed embodiments (especially in the context of the following claims), are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise be read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
maintaining, by one or more processors of a computing device, a knowledge graph comprising a plurality of nodes associated with respective sets of digital assets of a digital asset collection stored at the computing device;
receiving, at a user interface of the computing device, selection of a collection of related digital assets;
identifying, by the one or more processors and based at least in part on the selection, a set of digital assets associated with the collection of related assets, the set of digital assets being associated with a collection node of the plurality of nodes of the knowledge graph, the collection node corresponding to the selection;
generating, by the one or more processors, a subset of digital assets from the set of digital assets identified based at least in part on capture time data associated with respective digital assets of the set of digital assets;
generating, by the one or more processors and utilizing a neural network, content metadata for each of the digital assets of the subset of digital assets, the content metadata for a digital asset including a plurality of confidence scores that individually describe a degree of confidence that a feature is included in the digital asset;
calculating, by the one or more processors, a distance value quantifying a degree of similarity between first content metadata associated with a first digital asset of the subset of digital assets and second content metadata associated with a second digital asset of the subset of digital assets;
based at least in part on a determination that the distance value is below a threshold value, generating a filtered set of digital assets that includes the first digital asset and excludes the second digital asset from the filtered set of digital assets; and
presenting, at a display of the computing device and based at least in part on the selection, the filtered set of digital assets as being associated with the collection of related digital assets.

2. The computer-implemented method of claim 1, wherein the neural network is trained with previously categorized digital assets to identify a plurality of features, wherein the neural network is configured to receive the digital asset as input, and wherein the neural network is configured to output content metadata for the digital asset.

3. The computer-implemented method of claim 1, wherein the feature corresponds to at least one of: an object that appears in the digital asset or a characteristic of the digital asset.

4. The computer-implemented method of claim 1, wherein calculating the distance value includes comparing a first plurality of confidence scores of the first content metadata to a second plurality of confidence scores of the second content metadata.

5. A computing device, comprising:
one or more memories; and
one or more processors in communication with the one or more memories and configured to execute instructions stored in the one or more memories to cause the computing device to:
obtain a knowledge graph of a collection of metadata associated with a collection of digital assets stored at the computing device;
receive, at a user interface, selection of a collection of related digital assets;
determine a set of digital assets associated with the collection of related digital assets based at least in part on the knowledge graph;
determine a subset of digital assets from the set of digital asset based at least in part on capture times associated with each digital asset of the set of digital assets;
generate content metadata for each digital asset of the subset of digital assets, the content metadata for each digital asset of the subset of digital assets including a plurality of confidence scores that individually describe a degree of confidence that a feature is included in a digital asset;
identify two or more semantically similar digital assets based at least in part on corresponding content metadata of the subset of digital assets;
generate a filtered set of digital assets that includes one of the two or more semantically similar digital assets; and
present, at the computing device, the filtered set of digital assets.

6. The computing device of claim 5, wherein the two or more semantically similar digital assets are identified based at least in part on:
comparing the content metadata for each digital asset of the subset of digital assets to other content metadata of the subset of digital assets to determine two or more semantically similar digital assets; and
generating one or more distance values that individually quantify a degree of similarity between two digital assets based at least in part on comparing the content metadata for each digital asset of the subset of digital assets to other content metadata of the remaining digital assets of the subset of digital assets, wherein two digital assets are considered semantically similar when a corresponding distance value is less than a threshold value.

7. The computing device of claim 5, wherein the one or more processors execute further instructions to cause the computing device to:
prepare for display a user interface that includes user interface elements, each user interface element of the user interface elements identifying the collection of related digital assets and a corresponding multimedia icon that represents a corresponding digital asset associated with the collection of related digital assets; and
receive a selection of at least one of the user interface elements, wherein the filtered set of digital assets is presented based at least in part on the selection received.

8. The computing device of claim 5, wherein digital assets of the collection of related digital assets are related by at least one metadata attribute including an event, a location, content, a capture time, or a subject.

9. The computing device of claim 5, wherein the one or more processors execute further instructions to cause the computing device to present, with the filtered set of digital assets, additional collections of digital assets that relate to the filtered set of digital assets by at least one attribute of corresponding metadata of the filtered set of digital assets.

10. The computing device of claim 5, wherein the one or more processors execute further instructions to cause the computing device to receive, at a user interface of the computing device, a selection associated with a filter option, wherein additional digital assets of the set of digital assets is presented with the filtered set of digital assets.

11. The computing device of claim 5, wherein the one or more processors execute further instructions to cause the computing device to:
provide, at the user interface, a video including the filtered set of digital assets.

12. The computing device of claim 5, wherein the filtered set of digital assets is generated by:
determining a plurality of aesthetic scores associated with the two or more semantically similar digital assets;
selecting a highest aesthetic score of the plurality of aesthetic scores; and
including, in the filtered set of digital assets, a particular digital asset associated with the highest aesthetic score.

13. The computing device of claim 5, wherein generating the content metadata for each digital asset of the subset of digital assets includes providing, to a neural network, each digital asset of the subset of digital assets as input, the neural network being previously trained to identify one or more features appearing in an inputted digital asset, the neural network outputting the content metadata for each digital asset of the subset of digital assets, the content metadata including a plurality of confidence scores that individually describe a degree of confidence that a feature of the one or more features appears in a digital asset.

14. A computer-readable medium storing a plurality of instructions that, when executed by one or more processors of a computing device, cause the one or more processors to perform operations comprising:
receiving, at a user interface, a selection of a collection of related digital assets associated with one or more digital assets of a digital asset collection;
identifying the one or more digital assets associated with the collection of related digital assets;
determining a subset of digital assets from the one or more digital assets based at least in part on capture times associated with each of the one or more digital assets;
generating content metadata for each digital asset of the subset of digital assets, the content metadata including a plurality of confidence scores that individually describe a degree of confidence that a feature is included in a digital asset;
identifying two or more semantically similar digital assets based at least in part on corresponding content metadata of the two or more semantically similar digital assets;
generating a filtered set of digital assets, the filtered set of digital assets excluding at least one of the two or more semantically similar digital assets; and
presenting, at the computing device, the filtered set of digital assets.

15. The computer-readable medium of claim 14, wherein filtered set of digital assets is generated by obtaining aesthetic scores for the two or more semantically similar digital assets and including, in the filtered set of digital assets, a digital asset corresponding to a highest aesthetic score of the aesthetic scores, the aesthetic scores individually quantifying a quality of content of each of the two or more semantically similar digital assets.

16. The computer-readable medium of claim 14, wherein the feature corresponds to at least one of: an object that appears in the digital asset or a characteristic of the digital asset.

17. The computer-readable medium of claim 14, wherein the one or more processors perform further operations comprising:
identifying subjects of the filtered set of digital assets based at least in part on executing facial recognition techniques with the filtered set of digital assets; and
presenting, with the filtered set of digital assets, icons corresponding to the subject identified.

18. The computer-readable medium of claim 14, wherein the filtered set of digital assets provides a representative set of digital assets of the one or more digital assets that excludes duplicative digital assets.

19. The computer-readable medium of claim 14, wherein the feature includes a combination of objects appearing in a digital asset.

20. The computer-readable medium of claim 14, wherein a common feature included in the two or more semantically similar digital assets appears in different locations within the two or more semantically similar digital assets.
